(19) United States
(12) Patent Application Publication
(10) Pub. No.: US 2002/0064355 A1
(43) Pub. Date: May 30, 2002

(54) Automatic fiber preparation unit for splicing

(76) Inventors: Scot K. Ware, Brentwood, TN (US); Brett G. Clark, Whites Creek, TN (US); Michael Royce Cripps JR., Murfreesboro, TN (US); David Wayne Sellers, Franklin, TN (US); Jared Cassidy Meitzler, Franklin, TN (US); Jason Thomas Troyer, Brentwood, TN (US)

Correspondence Address: BANNER & WITCOFF, 1001 G STREET N W, SUITE 1100, WASHINGTON, DC, 20001, US

(21) Appl. No.: 09/933,120

(22) Filed: Aug. 21, 2001

Related U.S. Application Data
(63) Continuation-in-part of application No. 09/725,054, filed on Nov. 29, 2000.

(51) Int. Cl. G02B 6/255

(52) U.S. Cl. 385/95

(57) ABSTRACT

Apparatuses and methods for automatically preparing optical fibers for splicing (or for attachment to a connector or an optical component) by automatically positioning a stripping station, a cleaning station, and a cleaving station to process one or more optical fibers substantially simultaneously. The optical fiber may be held at a fixed position during processing. A vacuum system may further be used to automatically collect scrap produced by the cleaving process.

The present application claims priority to U.S. patent application Ser. No. 09/725,054, entitled “Automatic Fiber Preparation Unit for Splicing,” filed Nov. 29, 2000, which is incorporated by reference herein as to its entirety.

### FIELD OF THE INVENTION

The present invention relates to apparatuses and methods for automatically preparing optical fibers for uses such as splicing or attachment to a connector or optical component, and more particularly to an automatic fiber preparation unit that prepares an optical fiber by automatically positioning an optical fiber at a stripping station, a cleaning station, and a cleaving station, and methods relating thereto.

### BACKGROUND OF THE INVENTION

In the optical fiber industry, preparing optical fibers for splicing or attachment to a connector or an optical component is a common practice. For example, to splice two optical fibers together, the following steps are usually performed in the following order: stripping of the protective coating from a portion of the ends of the optical fibers; cleaning of the optical fiber ends, such as through use of an ultrasonic cleaner; cleaving the optical fibers to produce a clean tip suitable for splicing; placing the cleaved optical fiber into a splicer and splicing the optical fiber with another optical fiber; testing the splice; and finally covering the splice with a protective coating. Splicing is a delicate art and requires that the resulting splice meet strict physical requirements so as to limit the amount of light lost that passes through the splice when in use. Successful splicing also requires that each step in the process be performed accurately and properly. If an optical fiber is not prepared properly, the quality of the splice will be low regardless of the care taken in the splicing step.

Individual machines exist for performing various splicing and splicing-related operations on an optical fiber. However, these machines are often quite large and heavy. Also, the fiber preparation stage is manually intensive normally requiring human interaction to move the fibers from machine to machine to prepare the fibers for splicing. This human interaction can be time consuming and result in high labor costs. Additionally, operator handling of the optical fibers between stages increases the risk of scratching and contaminating the fibers before splicing. This may lead to unsatisfactory splices that reduce the performance of the splices or require the splices to be discarded.

Also, some conventional splice preparation machines physically wipe clean an optical fiber, often by rubbing tape against the optical fiber or by some other method involving physical contact with the optical fiber. Such techniques are more likely to damage optical fibers as they are rather delicate, especially once optical fibers have been stripped. Improvements are needed in order to clean stripped optical fibers with less risk of damage.

### SUMMARY OF THE INVENTION

There is a need for a simpler and commercially feasible device that prepares optical fibers for splicing or attachment to a connector or optical component. Such a device should preferably be compact and reliable. Such a device should further preferably provide a high throughput and minimize human intervention so as to lower the time and labor costs required in preparation of the optical fibers for splicing. Also, such a compact device would preferably have the capability of processing multiple optical fibers simultaneously in order to save time and money.

Stripping, cleaning, and cleaving may be performed on one or more optical fibers without the need to move the optical fibers from their fixed locations. Instead, an apparatus may be provided that may have a stripping station, a cleaning station, and a cleaving station. Each of these stations may move in various directions to process the optical fibers. The cleaning station may be a shower-type cleaning station. The stripping station may have a spinning cleaving disk that inscribes or otherwise cleaves the optical fibers. The cleaving disk may utilize a two-step approach, or an otherwise varied-speed approach, toward the optical fibers in order to reduce cleaving time while maintaining a high-quality cleave. For example, the cleaving disk may move toward the optical fibers at a first speed, and then as the cleaving disk approaches the optical fibers at a certain distance from them, approach at a second speed slower than the first speed. One or more of the stations may process multiple optical fibers simultaneously. The system may further utilize a vacuum system for automatically collecting scrap generated by the cleaving process.

The invention is meant to include one or more elements from the apparatus and methods described herein and in the applications incorporated by reference in any combination or subcombination. Accordingly, there are any numbers of alternative combinations for defining the invention, which incorporate one or more elements from the specification (including the drawings, claims, and applications incorporated by reference) in any combinations or subcombinations.

### BRIEF DESCRIPTION OF THE DRAWINGS

The foregoing summary of the invention, as well as the following detailed description of preferred embodiments, is better understood when read in conjunction with the accompanying drawings, which are included by way of example, and not by way of limitation with regard to the claimed invention. In the accompanying drawings, the same reference number in different drawings refers to the same or substantially the same element.

FIGS. 1A-1C are side views of an exemplary embodiment of an automatic fiber preparation unit having an optical fiber being positioned at first, second, and third stages, respectively, according to aspects of the present invention.

FIG. 1D is a top view of the automatic fiber preparation unit of FIG. 1C.

FIG. 1E is a side view of an alternative exemplary embodiment of an automatic fiber preparation unit according to aspects of the present invention.

FIGS. 1F-1H are side views of another alternative exemplary embodiment of an automatic fiber preparation unit having an optical fiber being positioned at first, second, and third stages, respectively, according to aspects of the present invention.

FIGS. 2A-2C are side views of another exemplary embodiment of an automatic fiber preparation unit having an optical fiber being positioned at first, second, and third stages, respectively, according to aspects of the present invention.

FIG. 3 is a side view of yet another exemplary embodiment of an automatic fiber preparation unit, according to aspects of the present invention.

FIG. 4 is a side view of still another exemplary embodiment of an automatic fiber preparation unit, according to aspects of the present invention.

FIGS. 5A-5C are top, side, and front views, respectively, of another exemplary embodiment of an automatic fiber preparation unit in a home position, according to aspects of the present invention.

FIG. 6 is a top view of the automatic fiber preparation unit of FIGS. 5A-5C in a first position during a stripping step according to aspects of the present invention.

FIG. 7A is a top view, and FIGS. 7B and 7C are side views, of the automatic fiber preparation unit of FIGS. 5A-5C in a second position during a cleaning step, according to aspects of the present invention.

FIG. 8 is a top view of the automatic fiber preparation unit of FIGS. 5A-5C in a third position during a cleaving step with the cleaving devices moved to a cleaving position, according to aspects of the present invention.

FIG. 9 is a top view of the automatic fiber preparation unit similar to FIG. 8 showing the cleaving devices moved to an initial position according to aspects of the present invention.

FIG. 10 is a flow chart illustrating the steps in an exemplary process for automatically preparing an optical fiber for splicing, according to aspects of the present invention.

FIGS. 11A-11C are side views of another embodiment of an automatic fiber preparation unit during first, second, and third steps, respectively, according to aspects of the present invention.

FIGS. 11D and 11E are front views of the automatic fiber preparation unit of FIGS. 11A-11C during the first and second steps, respectively, according to aspects of the present invention.

FIGS. 12 is a plan view of another exemplary embodiment of an automatic fiber preparation unit according to aspects of the present invention.

FIG. 13 is a side view of the automatic fiber preparation unit of FIG. 12.

FIGS. 14-17 are plan views of the automatic fiber preparation unit of FIG. 12 during various stages of operation, according to various aspects of the present invention.

FIGS. 18-20 are side views of an exemplary embodiment of a cleaving station during various stages of operation, according to aspects of the present invention.

FIG. 21 is a side view of an exemplary embodiment of a cleaving disk according to aspects of the present invention. 1301 FIG. 22 is a plan view of the cleaving disk of FIG. 21.

FIG. 23 is a plan view of an exemplary embodiment of a vacuum system according to aspects of the present invention.

FIG. 24 is a side view of the vacuum system of FIG. 23.

FIG. 25 is another side view of the vacuum system of FIG. 23, shown from a point of view 90 degrees from the side view of FIG. 24.

FIGS. 26(a)-26(c) illustrate constituent components of a first chamber part of an exemplary cleaning apparatus according to aspects of the present invention, FIGS. 26(a) and 26(b) being generally plan views and FIG. 26(c) being a perspective view;

FIGS. 27(a) and 27(b) illustrate opposite faces of a first constituent component of a second chamber part of an exemplary cleaning apparatus according to aspects of the present invention;

FIG. 28 illustrates a second constituent component of a second chamber part of an exemplary cleaning apparatus according to aspects of the present invention;

FIG. 29 is a schematic illustration of an exemplary cleaning apparatus according to aspects of the present invention;

FIG. 30 is an exploded view of an exemplary cleaning apparatus according to aspects of the present invention;

FIGS. 31(a)-31(e) schematically illustrate operation of an exemplary cleaning apparatus according to aspects of the present invention; and

FIG. 32 illustrates an exemplary embodiment of aspects of the present invention in which first and second chamber parts are hingedly attached and selectively engageable with each other.

### DETAILED DESCRIPTION OF EXEMPLARY EMBODIMENTS

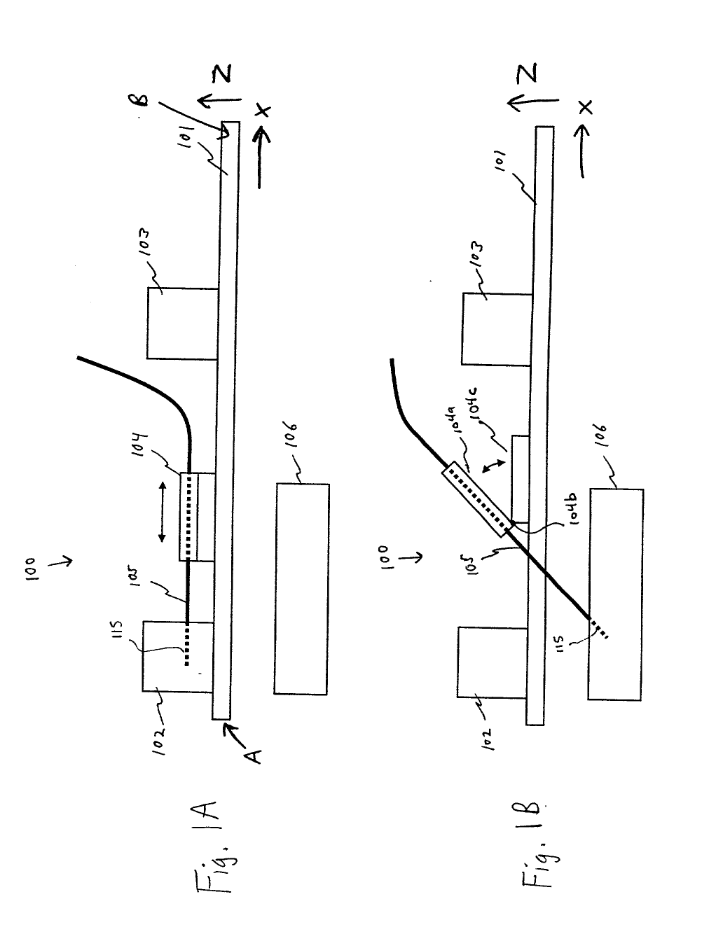

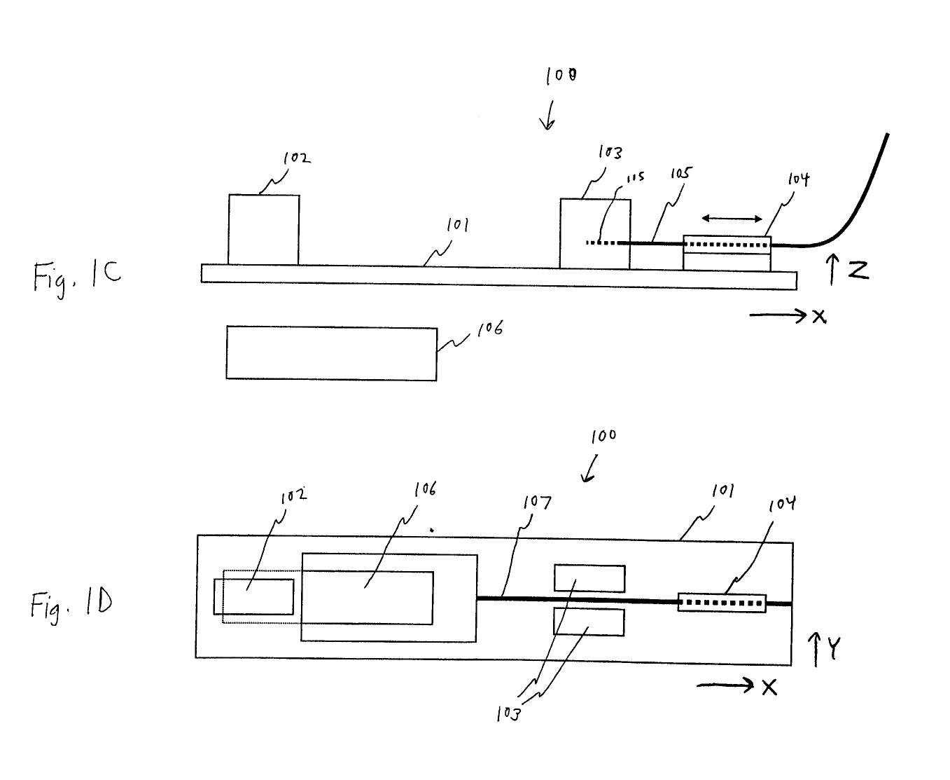

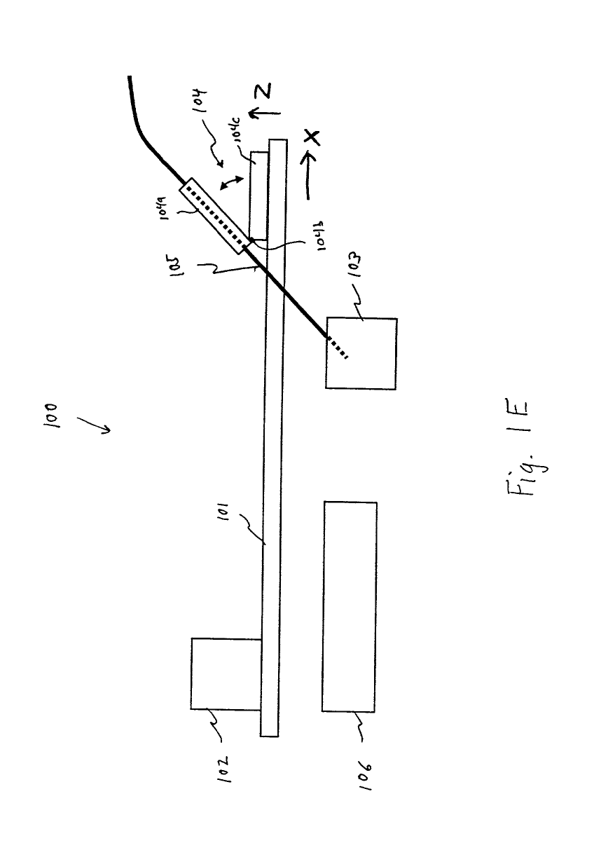

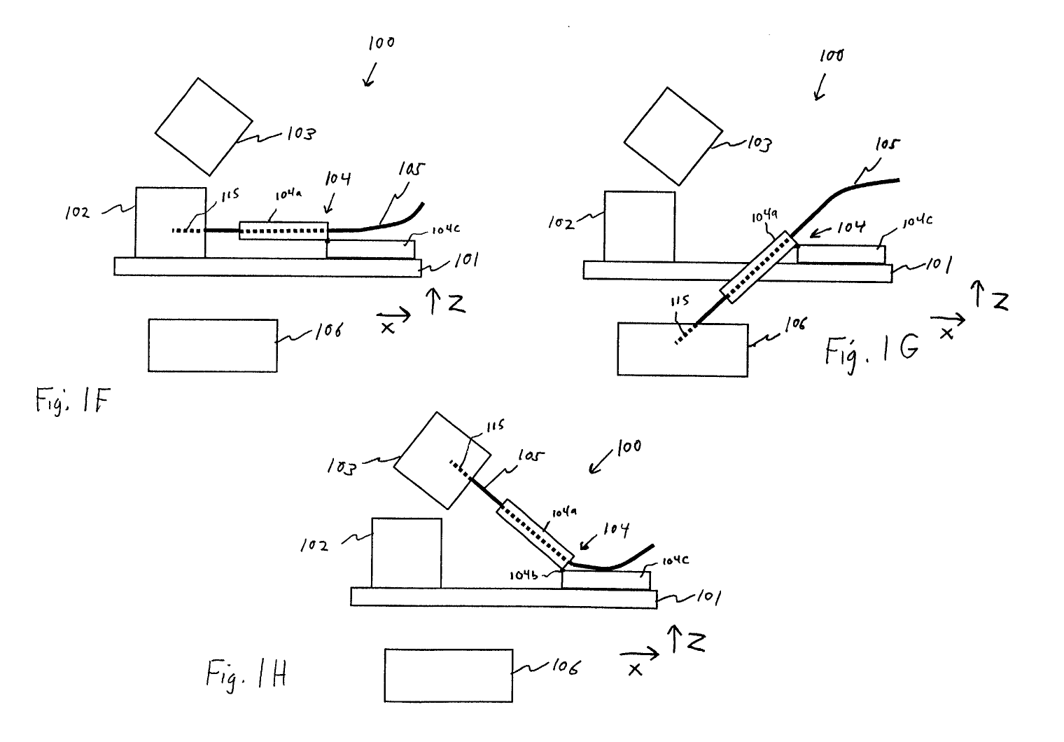

Referring to FIGS. 1A-1C, an exemplary automatic fiber preparation unit 100 (hereafter referred to as “unit 100”) is shown. This unit 100 is used to prepare optical fibers for splicing or attachment to a connector or an optical component. The unit 100 may include a main body 101 and a carriage 104 moveably coupled with to the main body 101. The term “main body” is a general term that includes within its scope a frame, casing, chassis, housing, body, or other similar structure. In the present example, the carriage 104 may slide along the main body 101 in a single dimension or axis (e.g., along the X-axis in the embodiment shown) in the manner shown by the arrows in FIG. 1A. An optical fiber 105 is coupled to the carriage 104 via a fiber holder or any other desired manner. In a preferred embodiment, the carriage 104 translates along an axis parallel to the longitudinal axis of the optical fiber 105 relative to the main body 101. The term “translate” as used herein refers to a movement other than rotation. Translation does not exclude the possibility of rotation simultaneously with the translation, but rotation alone does not constitute a translation of an object. For instance, pivoting, tilting, and rotating are not considered to be, by themselves, translations. Translation by sliding may be accomplished via a rail system or other known sliding system, and the carriage 104 may be translated in the X-axis relative to the main body 101 by any means such as by a rotary or linear motor(s) and/or pneumatic actuator(s) along with the appropriate drivers. Where a motor is used, it may be any desired motor type, e.g., of the direct-current permanent magnet type or a stepper motor.

The overall motion control for the carriage 104 may be implemented using any control logic technology. For instance, limit switches, relays, programmable logic controllers, embedded microprocessors, and/or programmable logic arrays, as are well known in the art, may be used in any combination or subcombination to control the motion of the carriage 104 and/or other elements of the unit 100.

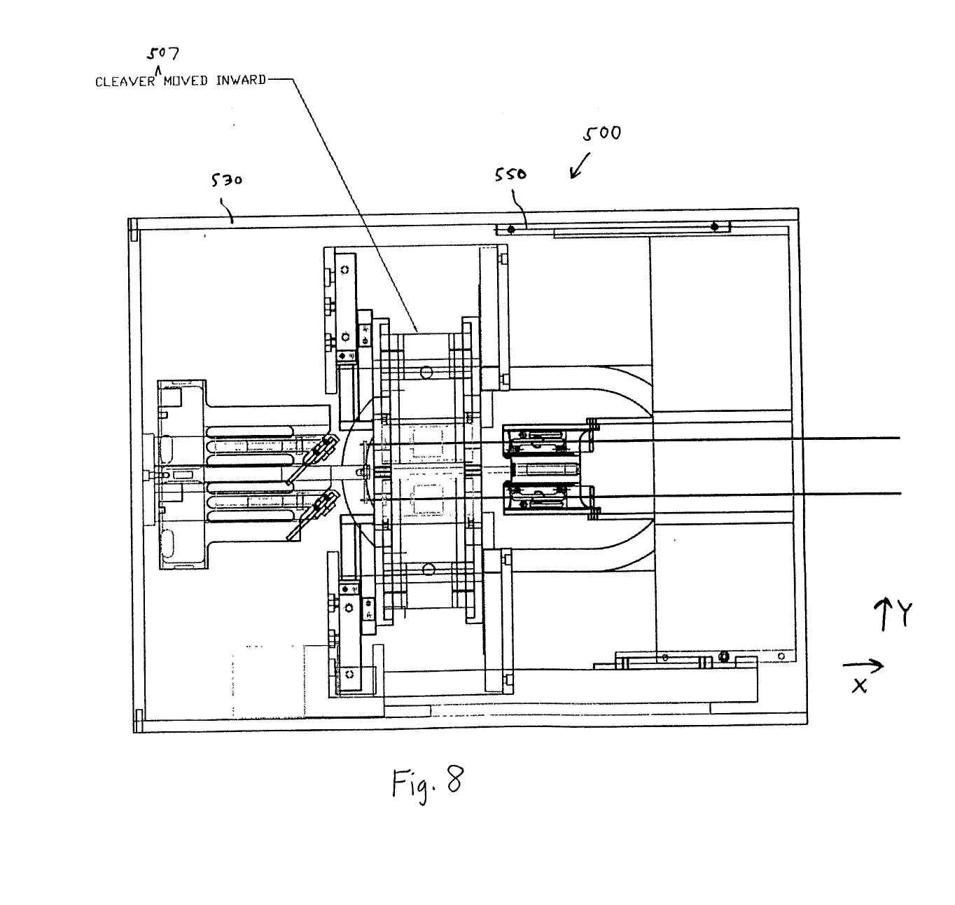

The carriage 104 may be configured to hold an optical fiber 105 directly and/or may be configured to receive an optical fiber holder with an optical fiber 105. The optical fiber 105 is preferably securely held by the carriage 104 to prevent relative movement therebetween. The optical fiber holder may be of any type such as that disclosed in U.S. Pat. No. 5,946,986 to Dodge et al., entitled “Optical Fiber Preparation Unit,” and incorporated herein as to its disclosure of an optical fiber holder, such as FIG. 8 of that patent and its related disclosure.

The unit 100 may further include a plurality of “stations” that may each perform a different function on or to the optical fiber 105. Each station may each be mounted or coupled to the common main body 101 or base. For instance, the unit 100 may include the following stations: a stripping station 102 for stripping the outer protective coating off the optical fiber 105, a cleaning station 106 such as an ultrasonic bath cleaner for cleaning the tip of the stripped optical fiber 105, and a cleaving station 103 for cleaving the optical fiber 105 to produce a reliably cut end face suitable for splicing with. The stripping, cleaning, and cleaving stations 102, 106, 103 may each comprise of individual components and may each function as independent units. Alternatively, the stations 102, 106, 103 may be implemented as interconnected units. For instance, the frames, chassises, and/or housings of the various stations 102, 106, 103 may be physically separate or combined/coupled together. Also, the stations 102, 106, 103 may be powered separately with different power supplies or together with a single power supply.

The stripping station 102 may include any type of optical fiber stripping device such as the HOT STRIPPERM device marketed by Amherst FiberOptics®, and/or be in accordance with the stripping device disclosed in U.S. Pat. No. 5,946,986 or 6,023,996 both to Dodge et al., and both entitled “Optical Fiber Preparation Unit,” and incorporated herein as to their disclosure of an optical fiber stripping device. The stripping station 102 may alternatively use other methods such as by blasting nitrogen onto the optical fiber 105. For mechanical stripping, the optical fiber 105 may be inserted manually by the user and/or aligned with the stripping blades, at the point that stripping should occur. Upon initiation of the automated unit 100, the blades of the stripping device would then automatically close and cut into the coating of the optical fiber 105. The optical fiber 105 would be translated relative to the blades to strip off the coating. This maybe done by translating the carriage 104 relative to the stripping device 106, either by moving the carriage 104 or the stripping device 106. The stripping device 106 preferably includes a heating element, not shown, to soften the coating of the fiber 105 for facilitating the stripping process. Further, it is recognized that any desirable actuator and mechanism may be used to control the relative position of the stripping blades.

The cleaning station 106 may include any type of cleaning device such as an ultrasonic cleaner. One such known ultrasonic cleaner is the model EUC 12 Ultrasonic Cleaner, marketed by Ericsson Cables. In a preferred embodiment, the cleaning station 106 includes an elongated or oblong ultrasonic bath, containing alcohol or a similar fluid, into which the optical fiber 105 may be dipped; not shown. An automated shutter, not shown, may be implemented over the surface of the bath in order to control evaporation and to maintain the purity of the fluid. To further maintain the purity of the fluid, a recirculating filter mechanism, not shown, may be utilized to recirculate the fluid through a filter. In a preferred embodiment, the optical fiber 105 is dipped into the bath at an angle such as about 30 to 45 degrees from the horizontal. In an alternative embodiment, the cleaning station 106 may operate by spraying a solvent such as alcohol onto the optical fiber 105.

The cleaving station 103 may include a cleaving device that preferably that produces high quality cleaves in a single step, such as the OFC 2000 or AFC 2000 automated cleaving device currently marketed by Oxford, a British company. However, the cleaving station 103 may cleave optical fibers in multiple steps and may include any type of optical fiber cleaving device.

As shown in FIG. 1A, the carriage 104 may be at a first position relative to the main body 101 so as to locate the free end portion 115 or tip of the optical fiber 105 to be stripped in the stripping station 102. The stripping station 102 preferably includes heating elements around the fiber end 115, as shown in U.S. Pat. Nos. 5,946,986 and 6,023,996, to heat the coating. Opposing blades, not shown, are moved together and into the coating. Stripping may thus occur by relative movement between the fiber and the blades. This may be accomplished by translating the carriage 104 in the positive X-axis direction (i.e., in FIG. 1A, toward the right side of the figure) so as to cause the optical fiber 105 to pull away from the stripping station 102 during the stripping process. Alternatively, the stripping device of the stripping station 102 may translate toward the negative X-axis direction (i.e., in FIG. 1A, toward the left side of the figure) in order to strip the optical fiber 105. Optionally, this could be accomplished by using both techniques.

As shown in FIG. 1B, the carriage 104 may then automatically slide or otherwise translate in the positive X-axis direction to a second position relative to the main body 101 so as to be able to position the tip of the optical fiber 105 in the cleaning station 106. In the exemplary embodiment shown, the carriage 104 may include at least two portions, one of which 104a may pivot or tilt at a pivot point 104b with respect to the other 104c in order to pivot the optical fiber 105 toward the cleaning station 106. In this case, the first portion 104a pivots about an axis 104b parallel to the Y-axis (the Y-axis direction being shown in FIG. 1D) such that the tip 115 of the optical fiber 105 is moved into the cleaning station 106 and the tip of the optical fiber 105 moves in a curve within the X-Z-plane. The pivotal movement may be caused by any desired arrangement such as a pneumatic piston and cylinder. In another embodiment, the entire carriage 104 may tilt, rotate, or pivot with respect to the main body 101 in order to pivot the optical fiber 105 toward the cleaning station 106. To make the unit 100 even more compact and simplified, it is preferable to pivot, rotate, or otherwise dip the tip of the optical fiber 105 into the cleaning station 106 (e.g., into the bath of the cleaning station 106) at an angle rather than vertically, such as at an angle 0 within the range of about 30 to 45 degrees from the horizontal, as shown for example in FIG. 1B. When the tip 115 of the fiber 105 has been cleaned, the top portion 104a may be pivoted by to the horizontal.

As shown in FIG. 1C, the carriage 104 may then automatically slide or otherwise translate along only the X-axis to a third position relative to the main body 101 so as to position the tip 115 of the optical fiber 105 in the area of the cleaving station 103. At this point, the cleaving station 103 may cleave the optical fiber 105 in order to produce a relatively clean free end surface with a perpendicular cut of the optical fiber 105 that is suitable for splicing. The cleaving station 103 may include a unit disposed off of the axis of the fiber 105 and move toward the fiber 105 for affecting the cleaving process. In a preferred embodiment, to make the system compact, the carriage 104 will have translated along only the X-axis for a distance of no more than about 1 foot from beginning to end, i.e., from the position shown in FIG. 1A to the position shown in FIG. 1C.

As shown by the top view of the unit 100 in FIG. 1D, the unit 100 may include one or more rails or slots 107, such as along the X-axis, coupled to the main body 101, along which the carriage 104 may travel. Further, the main body 101 may have an opening through which the optical fiber 105 may be pivoted downward into the cleaning station 106.

The cleaving station 103 may alternatively be disposed at a location spaced from the axis of motion of the carriage 104 and/or away from the main body 101, as shown in FIG. 1E. In such a case, the cleaving station 103 may preferably be oriented at an angle where the carriage 104 may pivot the optical fiber 105 downward (for instance) toward the cleaving station 103 as it does with regard to the cleaning station 106.

As can thus be seen by way of FIGS. 1A-1E, the carriage 104 preferably travels along a single axis (e.g., the X-axis) throughout the stripping, cleaning, and cleaving process. One reason that this is possible is that the stripping station 102, the cleaving station 103, and the optical fiber 105 are all aligned in the same plane. Such a configuration is simple and is relatively immune from error due to misalignment and other inaccuracies. Such a configuration also allows the unit 100 to be integrated while relatively compact. Also, it is preferable that only the steps of stripping, cleaning, and cleaving be performed by the unit 100, but not further steps involved in the splicing process. This allows for the unit 100 to remain compact and portable, and even may allow the unit 100 to be incorporated or integrated into another larger machine that performs further splicing functions.

In an another alternative embodiment as shown by way of FIGS. 1F-1H, the carriage 104 may have a base 104c that does not translate along the main body 101, but instead may remain in place during the processing of the optical fiber 105 while another portion 104a of the carriage 104 pivots up and down (and/or left and right) about a hinge 104b to position the tip 115 of the optical fiber 105 to the various stations 102, 106, and 103. Accordingly, stations 102, 103 and 106 are angularly disposed and spaced equidistant from the hinge point 104b. Such a configuration requires even less complex movement and may therefore be a desirable alternative. Any desirable arrangement, such as a piston cylinder coupled to the two portions 104a and 104b of the carriage 104, may be used to affect the pivotal movement of the pivoting portion 104a. In still another embodiment, a ball joint may be utilized to allow the optical fiber 105 to be maneuvered in any of the three X, Y, and Z dimensions.

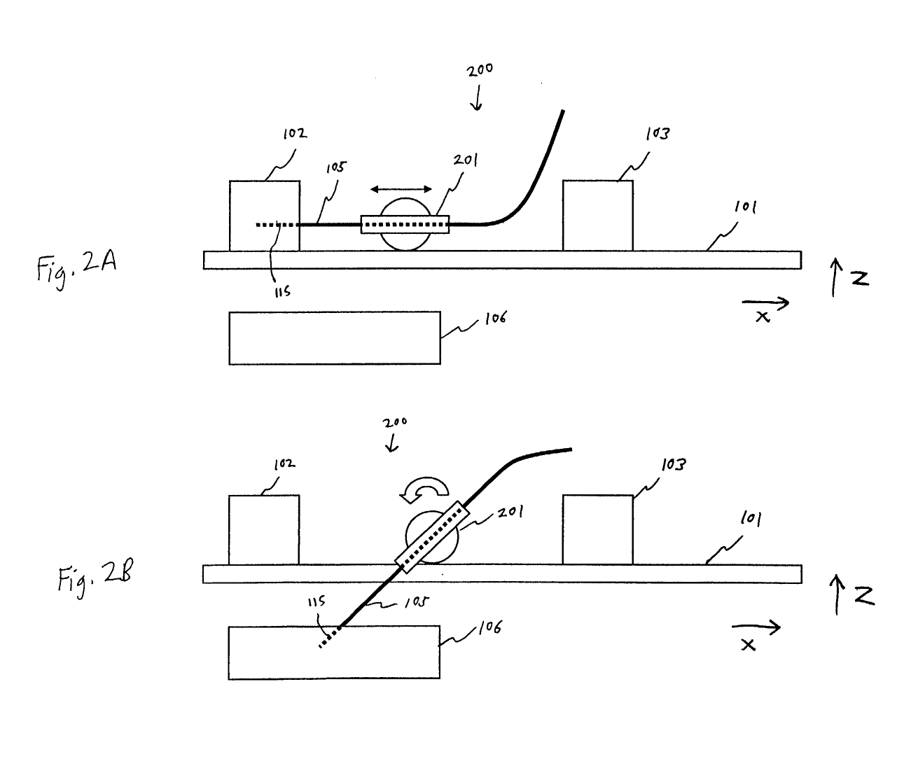

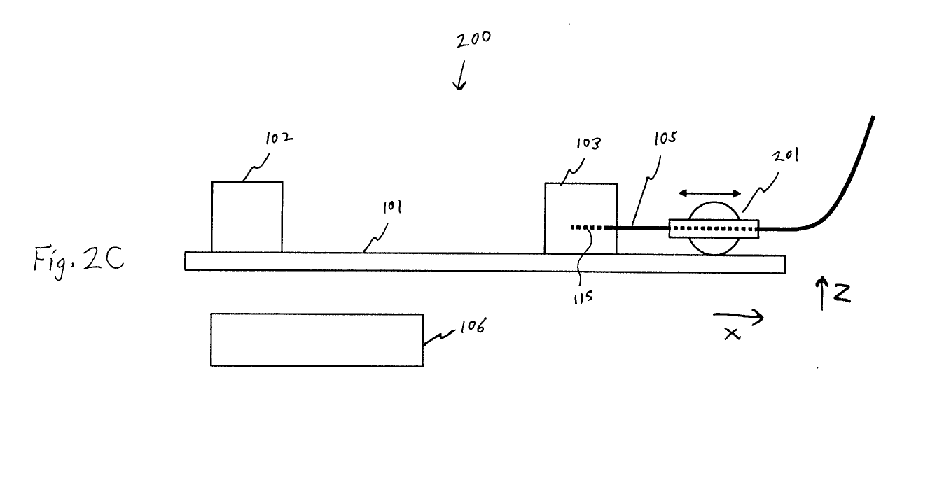

In another alternative embodiment, the carriage 104 may instead be configured as shown in FIGS. 2A-2C. In this embodiment, an automatic fiber preparation unit 200 may have a carriage 201 that translates along a single dimension or axis and also rotates as shown in FIG. 2B to cause the optical fiber 105 to be placed in the cleaning station 106.

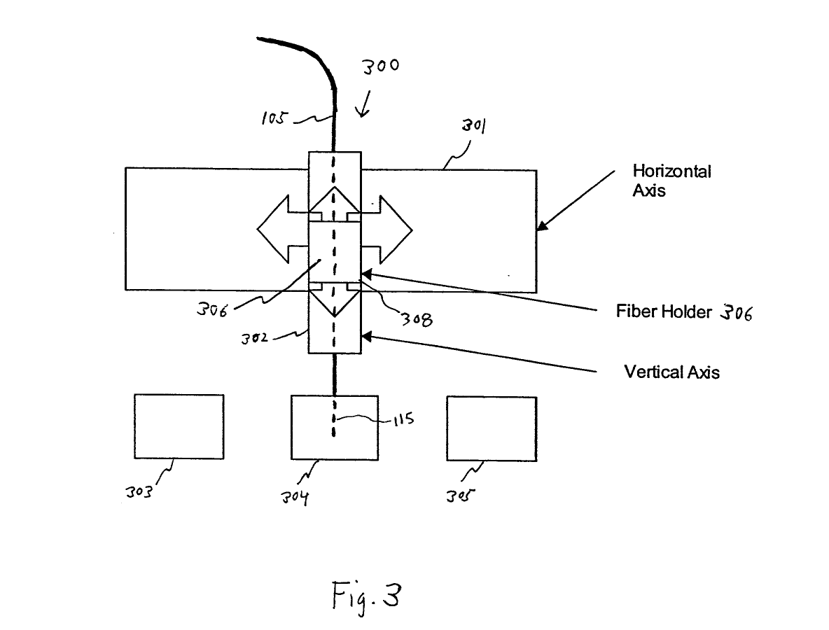

Another exemplary embodiment is shown in FIG. 3, in which an automatic fiber preparation unit 300 translates the optical fiber 105 independently in two orthogonal directions using vertical and horizontal carriages 302, 308 in order to maneuver the optical fiber 105 into various stations 303-305, which may be stripping, cleaning, and cleaving stations, respectively. In this embodiment, the unit 300 may have a main body 301 to which is moveably coupled an optical fiber holder 306 that can translate independently in both the horizontal and vertical directions. Movement may also in this case be provided by motors and/or pneumatic actuators. For instance, there may be provided a motor for controlling horizontal translation of the first carriage 302 relative to the main body 301 and another motor for controlling vertical translation of the second carriage 308 relative to the first carriage 302. The fiber holder 306 may start in a first location above station 303 (e.g., a stripping station), and lower the tip 115 of the optical fiber 105 down into station 303. Then the fiber holder 306 and second carriage 308 may be raised up and translated horizontally by moving the first carriage 302 over above station 304 (e.g., a cleaning station), and subsequently the second carriage 308 can lower the tip 115 of the optical fiber 105 down into station 304. Then the fiber holder 306 and second carriage 308 may be raised up, and translated horizontally over above station 305 (e.g., a cleaving station), and subsequently the second carriage 308 can lower the tip 115 of the optical fiber 105 down into station 305. Then, the fiber holder 306 may again be raised up to remove the optical fiber 105 from station 305.

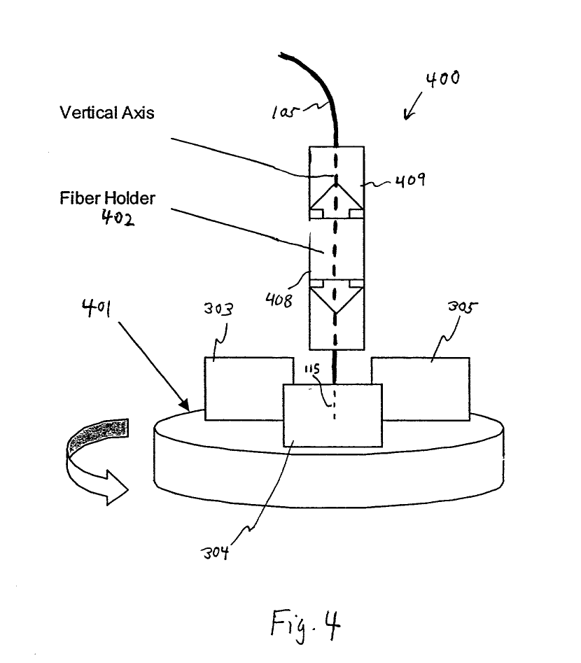

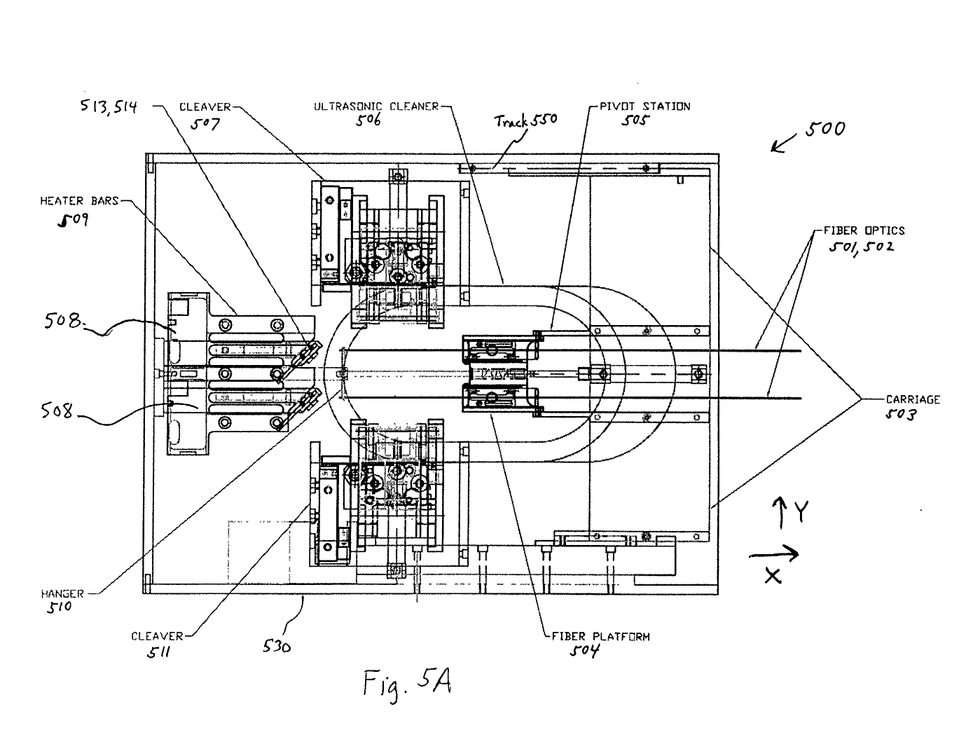

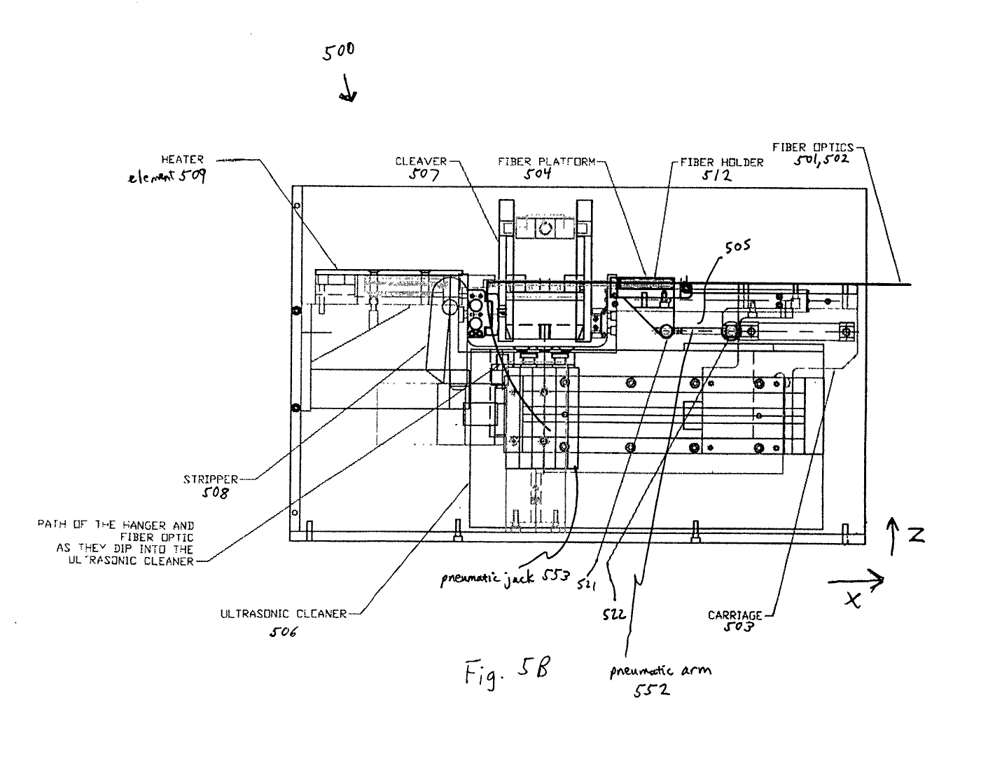

In yet another exemplary embodiment as illustrated in FIG. 4, an automatic fiber preparation unit 400 may include a rotary platform containing the stations 303, 304, 305. Here, the unit 400 may include an optical fiber holder 402 coupled to a carriage 408 that can translate along a single dimensional or axis (in this example, vertically) relative to a frame 409. A rotatable platform 401, body, or turret may selectively rotate to position a particular one of a plurality of stations such as stations 303-305 under the fiber holder 402. In this way, the tip 115 of the optical fiber 105 may be automatically lowered into and lifted from any one of the stations 303-305 as desired, such as in the same order described above with regard to FIG. 3.

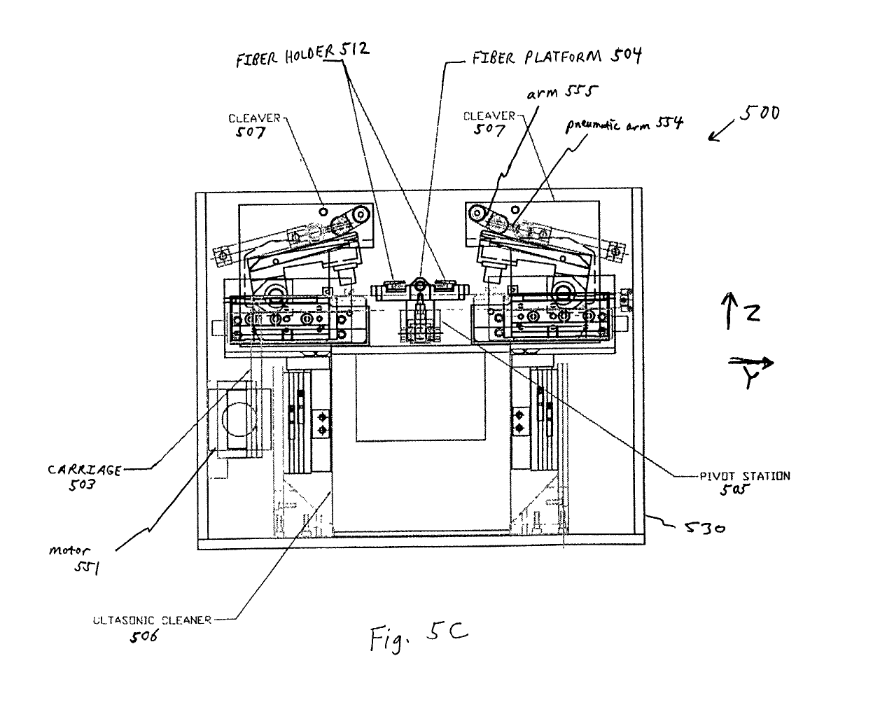

Referring now to FIGS. 5A-5C, an embodiment of an automatic fiber preparation unit 500 is shown which is similar to that as shown in FIGS. 1A-1D. This unit 500 preferably enables the automatic preparation of two fibers 501, 502 for splicing by the steps of stripping, cleaning, and cleaving. The unit 500 is preferably compact (e.g., about 8 inches in width along the Y-axis by about 12 inches in length along the X-axis by about 10 inches in height along the Z-axis) and incorporates strip, clean, and cleave operations of one or more optical fibers. The unit 500 may include any of the following in any combination or subcombination: one or more optical fiber holders 512 each for holding a respective optical fiber 501, 502; one or more fiber platforms 504 to which the fiber holders 512 are coupled and preferably temporarily affixed and that position the fiber holder 512 with precision; one or more pivot mechanisms 505 such as a pin coupled to the platform 504 in order to allow the platform 504 to pivot relative to a frame or main body 530; one or more moveable or slideable carriages 503 coupled to the main body 530 and carrying the platform 504 so as to translate the platform 504 along a single dimension or axis relative to the main body 530; one or more hangars 510 coupled to the optical fibers 501, 502 that support the ends of the optical fibers 501,502 to maintain them in a straight line, wherein the hangar 510 may be coupled to and supported by the carriage 503 or the platform 504; one or more strippers 508 for stripping the optical fibers 501, 502; one or more heater elements 509 (such as heater bars) as part of the stripping station for heating the optical fibers 501, 502 to allow for easier stripping; one or more ultrasonic cleaners 506 for cleaning the stripped portion of the optical fibers 501, 502; and/or one or more cleavers 507, 511 for cleaving the optical fibers 501, 502. In a preferred embodiment, the strippers 508, the cleavers 507, 511, and the optical fibers 501, 502 are within the same plane. The cleaner 506 may also be in the same common plane. The unit 500 may further include one or more controls and/or signal interfaces (not shown) for allowing a user or another apparatus (such as a computer) to control the operation of the unit 500 based on manual input or a preset program.

In the embodiment shown, multiple optical fibers 501, 502 may be processed in parallel and/or simultaneously by the unit 500. In such a situation, the multiple optical fibers 501, 502 may each have their own associated stripper 508 and their own associated cleaver 511, but may share a single ultrasonic cleaner 506, and more specifically, the same reservoir of the same ultrasonic cleaner 506. Moreover, if desired, the unit 500 may operate on only a single optical fiber at a time.

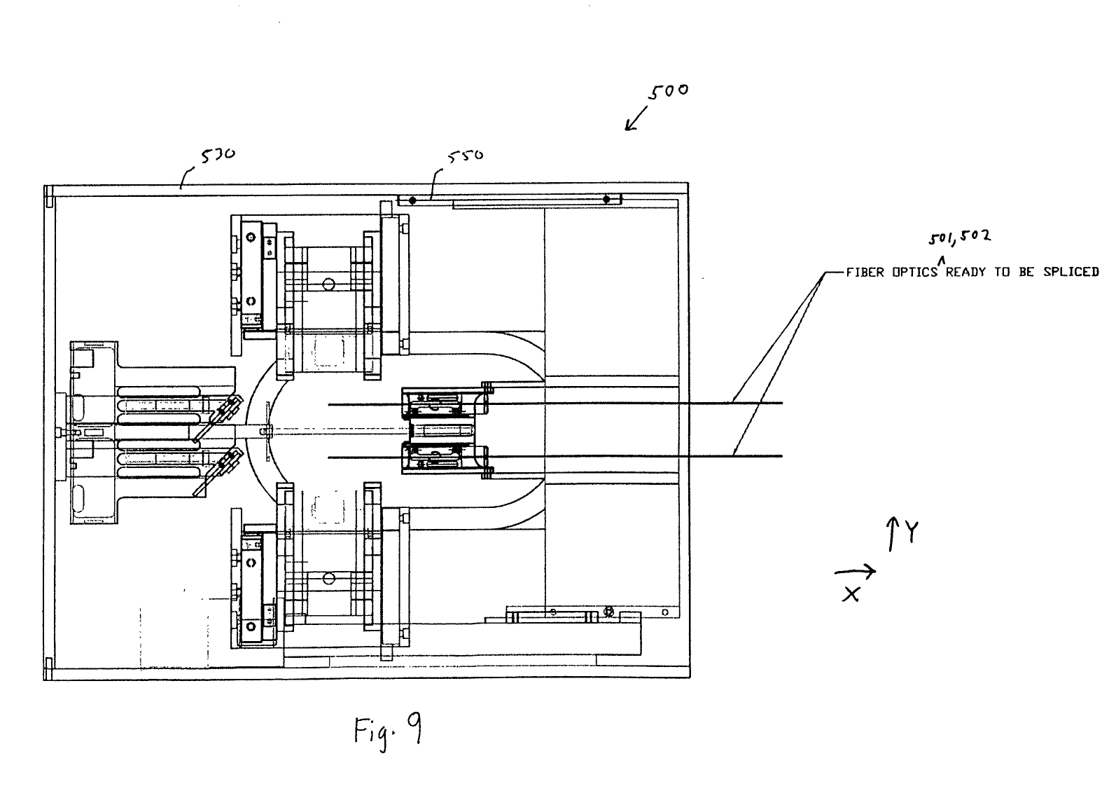

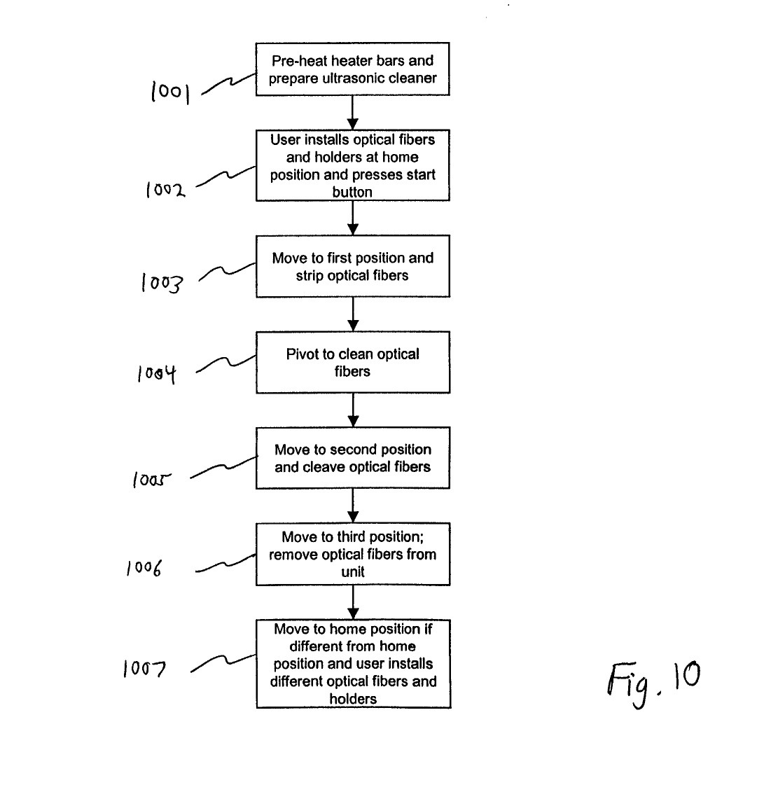

In operation, and referring to FIG. 10 in conjunction with FIGS. 5A-9, the exemplary unit 500 may perform a pre-processing step by bringing the heater element 509 to an appropriate temperature and/or by ensuring that the ultrasonic cleaner is ready for cleaning (step 1001). The unit 500 will preferably at this point be configured such that the carriage 503 and fiber platform 504 are in the “home” position. The home position is such that the optical fibers 501, 501 may be easily loaded in the unit 500. In this example, the home position is where the fiber platform 104 is horizontally disposed and the carriage 503 translate the platform 104 to the right side of the unit 500 such that the optical fibers 501, 502 are not disposed in any of the strippers 508, the ultrasonic cleaner 506, or the cleavers 507, 511. This allows for easy placement of the optical fibers 501, 502 into the unit 500. However, in an alternatively designated home position, the fiber platform 104 may be positioned such that the ends of the optical fibers 501, 502 may alternatively be disposed in their respective strippers 508 such that they are ready for stripping. In one embodiment, the optical fibers 501, 502 are preferably already coupled to their respective fiber holders 512. The fiber holders 512 may be placed in the unit 500 by coupling them to the platform 504. In a preferred embodiment, the fiber holders 512 and the platform 504 include magnets which provide a retentive magnetic attracting force when the fiber holders 512 are placed on the platform 504.

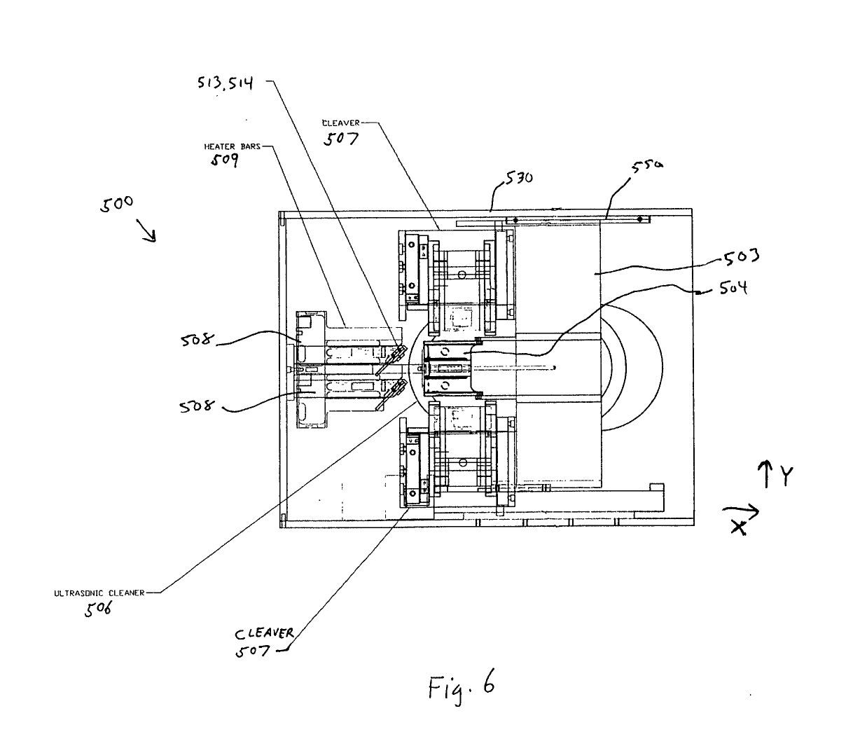

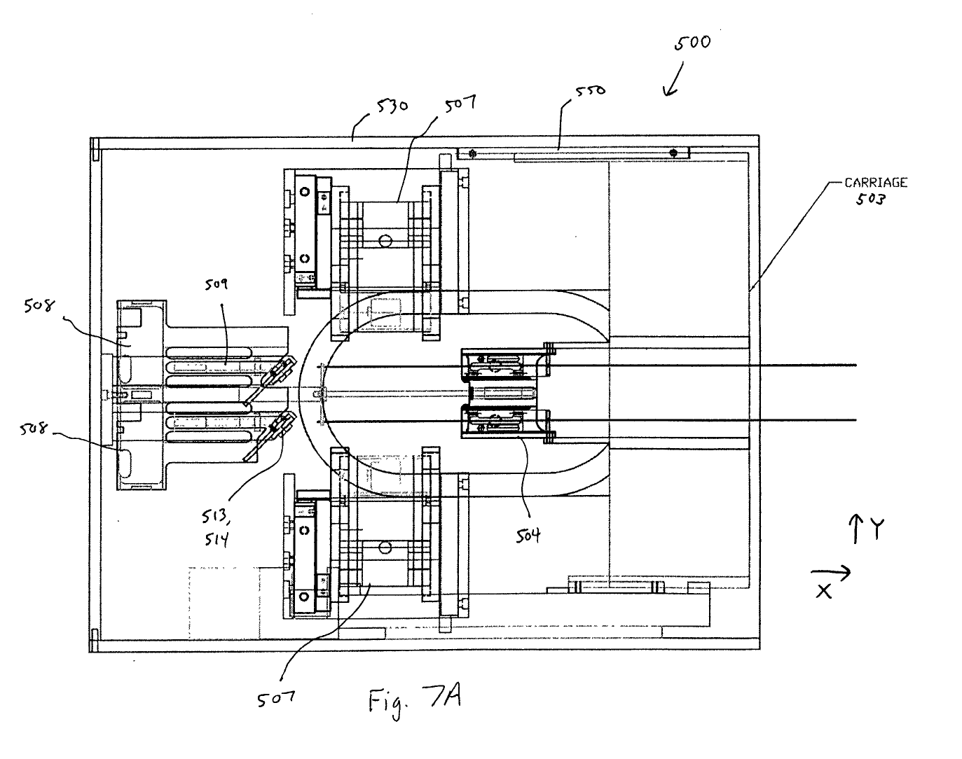

Next, the user may press a start button or otherwise instruct the unit 500 to begin operations (step 1002). This may alternatively be performed by a separate device such as a computer outputting a start signal to the unit 500 or upon the detection of the presence of one or both fiber holders 512 in the platform 504 as detected by any suitable sensor. In response, the carriage 503 may translate the platform 504 to a first position as shown in FIG. 6 (in this case the carriage 503 may translate along the X-axis) where the ends of the fibers 501, 502 are inside the strippers 508 and a portion of the fibers are behind the stripping blades. For example, as seen in FIG. 5a, the carriage 503 may be slideably coupled to the frame 530 by one or more linear tracks 550 and translated in a linear direction. The carriage 503 may be translated by an electric stepper motor 551 driving a worm screw as shown in FIG. 5C or any desired motor, linear actuator, and/or any other powered arrangement. In such a case, the worm screw may be coupled to the carriage 503 causing the carriage 503 to translate in a linear direction in response to the worm screw turning. Such a configuration is useful where it is desirable to vary the length of optical fiber 501, 502 that is stripped by the strippers 508 as needed. This is because the distance traveled by the carriage 503 is easily controlled by controlling the amount the worm screw turns.

The stripping blades 513 may be oriented in any desired direction, and the stripping blades 513 may preferably have handles 514. The handles 514 preferably extend upward or downward in the Z direction and may be disposed at an angle from the axis of the fiber 501,502. In the exemplary embodiment shown, at least one handle 514 as pivotally mounted relative to the other. A motor, pneumatic actuator, and/or any other desired arrangement may be used to control the movement of handles 514 so that the blades 513 properly engage the coating of the fiber 501, 502. Where a pneumatic actuator is used, one or more valves may be utilized to limit the air pressure applied, thus allowing for more accurate control of the pressure applied by the stripper.

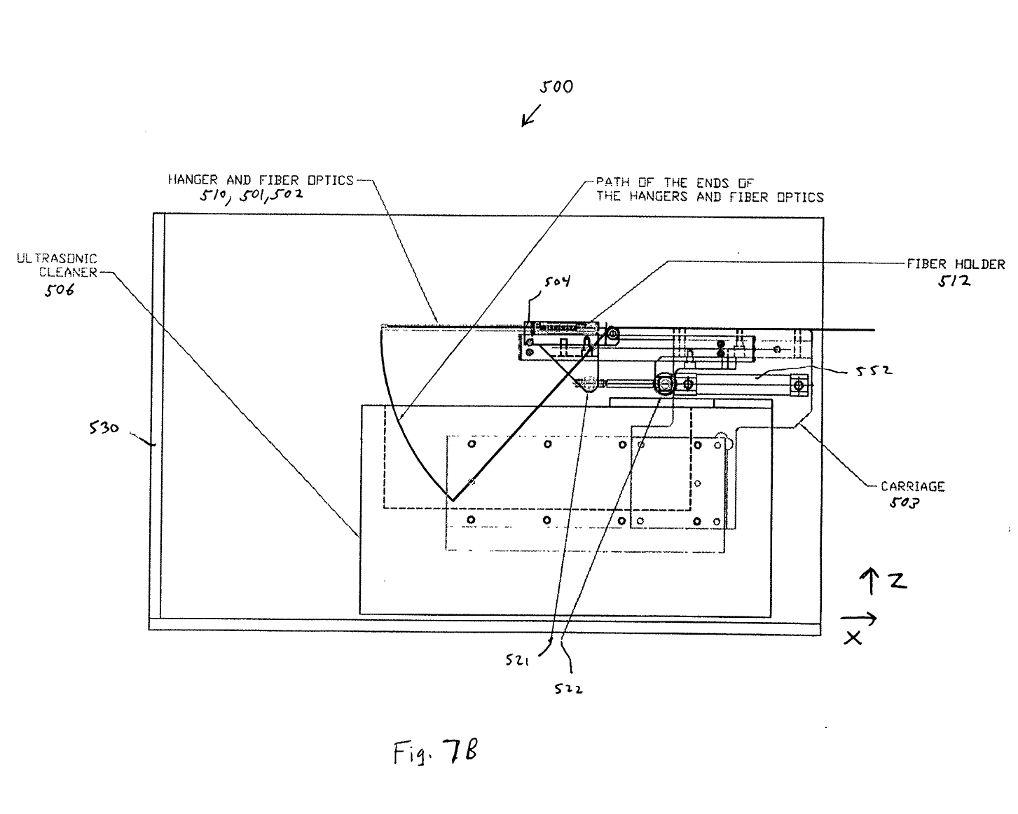

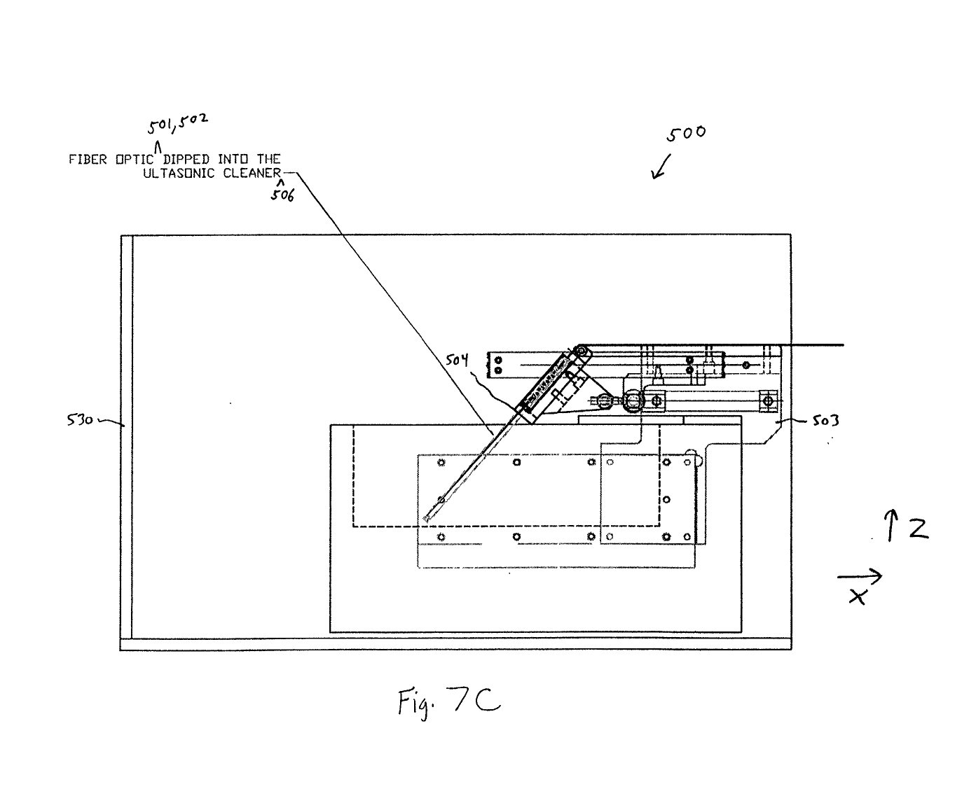

With the blades 513 engaging the coating of the fiber 501, 502, the fiber platform 504 is moved relative to the strippers 508 to increase the distance between the platform 504 and the strippers 508. By this separation, the stripping blades 513 help strip the coating off of the fibers 501, 502. The heater bars 509 facilitate this process. In a preferred arrangement, the separation can be caused by moving the carriage 503 in the positive X direction relative to the frame 530. This moves the platform 504 to a second position, as shown in FIGS. 7A and 7B, which may be the same as the home position of FIGS. 5A-SC. It is recognized that the strippers 508 may be moved in the negative X direction to accomplish this separation.

In this position, the optical fibers 501, 502 are supported and suspended at their free end by the hangar 510. At the pivot station 505, and actuator 552 may now pivot the fiber platform 504 (and thus the fiber holders 512) relative to the carriage 503 and the frame 530 about an axis extending in the Y direction. This dips the optical fibers 501 and/or 502 into the ultrasonic cleaner 506 (step 1004). To accomplish this, a pneumatic actuator 552 if the piston-cylinder type may be mounted at a first end 521 to the platform 504. The actuator 552 may be hinged or trunnion-mounted to the carriage 503 at its other end 522. In this embodiment, retracting the piston in the actuator 552 causes the platform 504 to pivot downwardly, with the tips of the optical fibers 501, 502 traveling in a curve within a Z-plane. The tips of the optical fibers 501, 502 will thereby be dipped into the ultrasonic cleaner 506. The hangar 510 may also follow with the optical fiber 501, 502 during the pivoting. The optical fibers 501, 502 may remain in the ultrasonic cleaner 506 for a predetermined time to ensure proper cleaning. A timer, which may be implemented manually and/or electronically (e.g., using a microcomputer and/or simple counting circuit), may be used to determine how long the optical fibers 501, 502 remain in the ultrasonic cleaner 506.

As seen most clearly in FIG. 5B, the pivot station 505 may include an extendible arm such as a pneumatic arm 552 including a piston that may extend and contract in order to pivot the platform 504. The pneumatic arm 552 may be hinged or trunnion-mounted to both a fixed point at one end and to a point of the platform 504 at the other end, thereby providing sufficient degrees of freedom to allow the platform 504 to pivot. Thus, when the pneumatic arm 552 contracts (such as is shown in FIG. 7C), the platform 504 pivots downward along the Z-axis, and when the pneumatic arm 552 extends (such as is shown in FIG. 5B), the platform 504 pivots upward along the Z-axis.

The platform 504 is then raised by extending the arm 552. Optionally, the carriage 502 may next translate the platform 504 to a different position along the X-axis in order to position the platform 504 so that the optical fibers 501 and/or 502 may be cleaved (step 1005). At this point, the platform 504 may pivot back up along the Z-axis to its original configuration, the carriage 502 may or may not translate toward the right of the figure in the positive X-axis direction, and the cleavers 507, 511 may be translated inward in the Y direction toward the optical fibers 501 and/or 502 to cleave the optical fibers 501, 502 in parallel, individually, and/or simultaneously. The cleavers 507, 511 may have their blades on the bottom or they may be inverted to have their blades on top of the optical fibers 501, 502.

In one exemplary embodiment, the cleavers 507, 511 may first translate inwardly in the Y-direction to a point below the optical fibers 501, 502, and then upward along the Z-axis so that the optical fibers 501, 502 rest in respective notches or grooves in the cleavers 507, 511. The cleavers may be translated inward and upward by electrical, pneumatic, and/or other arrangements. For instance, the cleavers 507, 511 may each be translated upward by a pneumatic jack 553 (FIG. 5B). The pneumatic jack 553 may include one, two, or more pistons (e.g., multiple pistons to improve the stability of the cleavers 507, 511) that raise each of the cleavers 507, 511 to the desired height. The cleavers 507, 511 may further be engaged to cleave the optical fibers 501, 502 by motor, pneumatic actuator, and/or other arrangements. For instance, a pneumatic arm 554 and a follower arm 555 (both FIG. 5C) may work together as a short pivoting linkage to push the tops of the cleavers 507,511 downward to cleave the optical fibers 501, 502. In this example, the pneumatic arm 554 extends to cause the follower arm 555 to push downward on the top of the cleavers 507, 511, and retracts to allow the cleavers 507, 511 to spring back upward against the follower arm 555. Where a pneumatic actuator is used, one or more valves may be utilized to limit the air pressure applied, thus allowing for more accurate control of the pressure applied by the cleaver.

Once the optical fibers 501, 502 are cleaved, the carriage 502 may translate toward the right of the figures in the positive X-axis direction, or not at all, to move the platform 504 to a third position (which may be the same as the home position) to allow for easy removal of the fiber holders 512 along with their respective optical fibers 501, 502 (step 1006). At this point, the carriage 502 may then translate the platform 504 back along the X-axis to the home position if necessary so as to be ready to receive another set of fiber holders with optical fibers (step 1007).

Once removed, the fiber holders 512 along with their respective optical fibers 501, 502 that have been stripped, cleaned, and cleaved, may be placed in a separate fusion splicer machine (not shown). This placement may occur manually by the user and/or automatically by a robot. Preferably, the fiber holders 512 are configured to be compatible not only with the unit 500 but also with the fusion splicer machine. In such a case, transferring of the optical fibers 501, 502 between the unit 500 and the splicer machine is quite easy and incurs a low risk of damage to the optical fibers 501, 502 since they need not be removed from the fiber holders 512 prior to splicing.

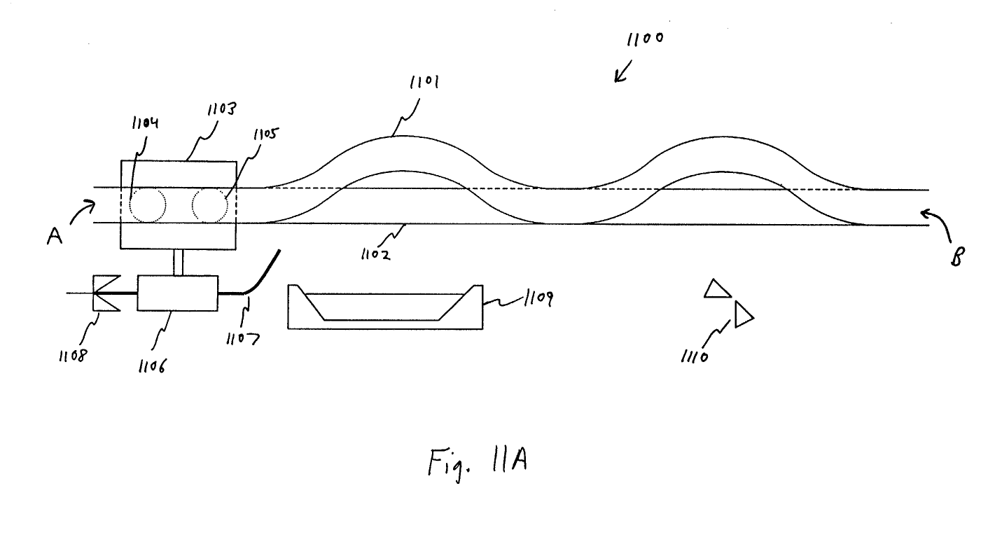

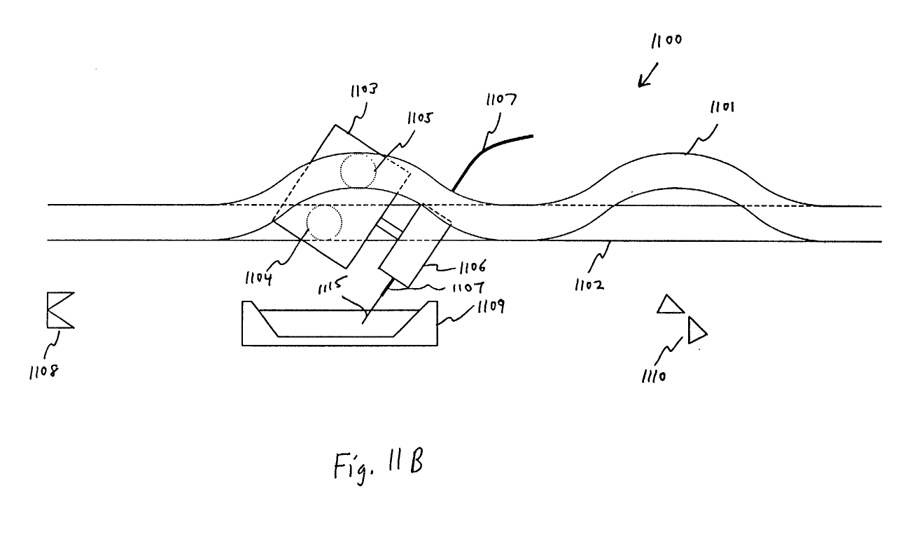

In another exemplary embodiment as shown by way of FIG. 11A., an automatic fiber preparation unit 1100 may include a shuttle-type carriage 1103 having at least two rotatable wheels 1104, 1105 that run along respective tracks 1101, 1102. The wheels 1104, 1105 may be rotatably coupled to the carriage 1103 with axles (not shown). The carriage 1103 may have an extension that receives with an optical fiber holder 1106 as described above. That is, the optical fiber holder 1106 can hold an optical fiber 1107 without slippage. The unit 1100 may further include a variety of stations suitable for preparing the optical fiber 1107 for splicing. In particular, the unit 1100 may preferably include stations similar to those in other embodiments: a stripper 1108, a cleaner 1109, and a cleaver 1110 each disposed at different respective locations of the unit 1100 along the tracks 1101 and 1102.

As shown in the side view of FIG. 11D, the fiber holder 1106 may have a hole 1111 for receiving the optical fiber 1107, such that the optical fiber 1107 maybe clamped in the fiber holder 1106 or otherwise fixed therein. The tracks 1101, 1102 may be of any shape that works to allow the wheels 1104, 1105 to travel along them. In the illustrated, the tracks are U-shaped and the wheels 1104, 1105 extend into the space defined by the tracks 1101, 1102. The carriage 1103 may be translated along the tracks 1101, 1102 by any arrangement such as one or more motors and/or pneumatic actuators.

In a preferred arrangement, one track is translating track 1102 and the other track is a platform orientation track 1101. Put another way, the platform orientation track 1101 should have at least one hump. If desired, the wheel 1104 in the straight track 1102 may be driven while the wheel 1105 in the orientation track 1101 may be an idler, i.e., freely rotatable. By driving the wheel 1104 in the straight track, the carriage 1103 will move along the tracks 1101, 1102 from left to right as shown in FIGS. 11A-11C. The idler wheel 1105 will follow in the other track 1101 causing the carriage 1103, and the fiber 1107 or fibers therein, to rotate upwardly and/or downwardly.

The operation of the unit 1100 is better understood via the series of FIGS. 11A-11C. As shown in FIG. 11A, the carriage 1103 and its wheels 1104, 1105 may be positioned at a location on the tracks such that the optical fiber 1107 is caused to be disposed in the stripper 1108. The optical fiber 1107 may then be stripped, either by moving the stripper 1108 and/or the carriage 1103, and the carriage 1103 may translate toward the right for the next operation.

Referring to FIGS. 11B and 11E, as the carriage 1103 translates toward the right of the figure, the idler wheel 1105 is forced to translate up with the track 1101 while the wheel 1104 remains along the straight path defined by the track 1102. The waviness of the track 1101 may be configured to rotate the carriage 1103 just the right amount to cause the optical fiber 1107 to dip into the cleaner 1109. Once the cleaning step has been completed, the carriage 103 may again be moved.

Referring to FIG. 11C, as the carriage 1103 continues toward the right of the figure, the wheel 1105 is now forced back down, possibly in line with the wheel 1104. This causes the tip of the optical fiber 1107 to not rub against the right side of the cleaner 1109. Then, the waviness of the track 1101 again causes the carriage 1103 to rotate to cause the optical fiber 1107 to dip downward, upward, or sideways, etc., so the optical fiber 1107 is within reach of the cleaver 1110. The carriage 1103 may be stopped and the cleaver 1110 may cleave the end of the optical fiber 1107.

Once the optical fiber 1107 has been cleaved, the fiber holder 1106 along with the optical fiber 1107 may be again driven and then removed from the right side of the tracks 1101, 1102 so that the optical fiber 1107 may be spliced by another apparatus. Also, a different fiber holder with another optical fiber may be placed into the left side of the tracks 1101, 1102 and the entire process repeated as for the previous optical fiber 1107. This type of serial pipeline processing saves time, and indeed more than one optical fiber and fiber holder may be on the tracks 1101, 1102 at the same time but in different locations along the tracks 1101, 1102, in order to save even more time. The motor for driving the driver wheel 1104 may be controlled by a timer and, if desired, synchronized with the operation of the stations 1108, 1109, 1110 for efficiency.

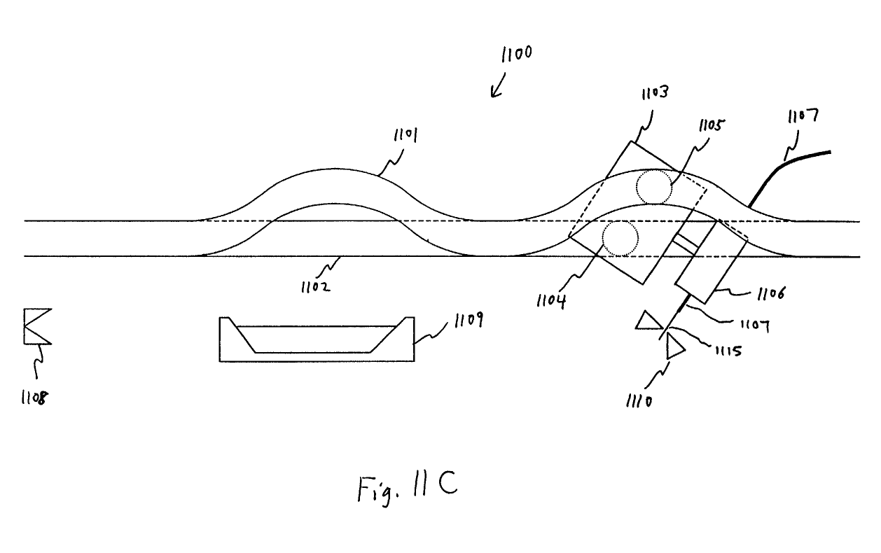

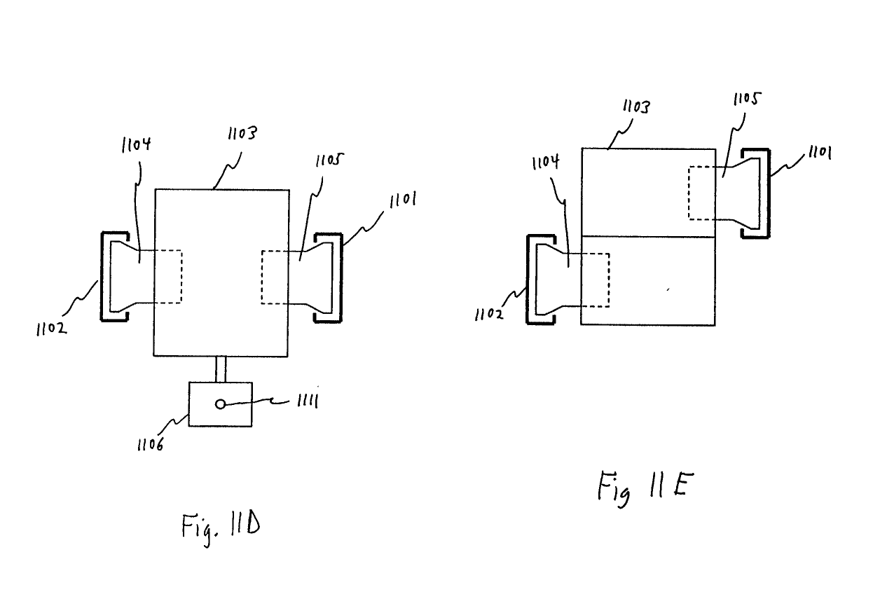

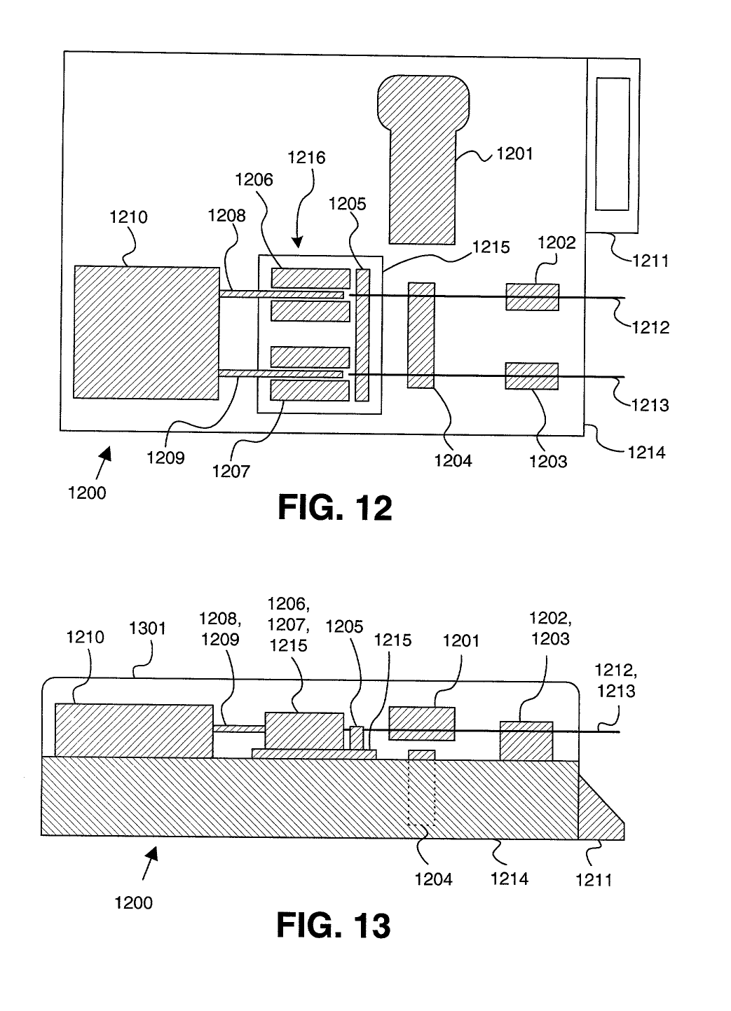

Referring to FIGS. 12 and 13, another exemplary embodiment of an automatic fiber preparation unit 1200 (“unit 1200”) is shown. Like previous embodiments discussed herein, the unit 1200 may include a main body 1214 coupled to a stripping station 1216, a cleaning station 1201, and/or a cleaving station 1204. In the present embodiment, however, one or more optical fibers 1212, 1213 may be held in a fixed position relative to the main body 1214 while the optical fibers are stripped, cleaned, and cleaved. Instead of moving or translating the optical fibers 1212, 1213, the various stations may translate relative to the main body 1214. The motion of each of these stations and other moving parts of the unit 1200 may be controlled by a central processing unit or other circuitry or mechanics. The main body 1214 may preferably be of a compact size such that it could be utilized as a table-top unit or mounted to a work surface. The unit 1200 could even be embedded into or otherwise incorporated with a work surface. In a preferred arrangement, the entire unit 1200 has compact dimensions that are less or equal to than 12 inches in width, 13 inches in depth and 9 inches in height. Accordingly, the footprint of the unit 1200 is preferably less than 576 square inches, and more preferably, less than 156 square inches. Additionally, overall cubic volume occupied by the unit 1200 is preferably less than 6912 cubic inches, and more preferably less than 1560 cubic inches. Additionally, the weight of the unit is preferably less than 30 pounds, and more preferably less than or equal to 23 pounds. While the unit may be made larger and/or heavier than these specifications, these specifications provide additional advantages relating to the compact nature of the unit 1200 including occupying less room on an assembly line, and increases the portability of unit 1200.

The stripping station 1216 of the unit 1200 may include any one or more types of stripping devices 1206, 1207, such as one or more HOT STRIPPERs, marketed by Amherst FiberOptics and/or be in accordance with the stripping device disclosed in U.S. Pat. No. 5,946,986 or 6,023,996 both to Dodge et al., and both entitled “Optical Fiber Preparation Unit,” and incorporated herein as to their disclosure of an optical fiber stripping device. Each of the stripping devices 1206, 1207 may include one or more stripping blades, and optionally one or more heating units for heating the optical fibers 1212, 1213. Each of the stripping devices 1206, 1207 may be configured to strip a different optical fiber 1212, 1213 substantially simultaneously with the other blades, in which case the multiple blades of the collective stripping devices 1206, 1207 may be physically separate and spaced from one another. In an alternative embodiment, a single blade may strip multiple optical fibers 1212, 1213 simultaneously.

The stripping station 1216 may be translationally moveable relative to the main body 1214, such as by being disposed on a translatable carriage 1215. The carriage 1215 may translate in the longitudinal direction of the optical fibers 1212, 1213 (in this example, in the left/right direction of FIG. 12). In an alternative embodiment, the optical fibers 1212, 1213 may be translated along their longitudinal axes instead of (or in addition to) the stripping station 1216 translating. In such an embodiment where the stripping station 1216 need not translate, the carriage 1215 would not be necessary.

The carriage 1215 may also carry one or more clamps 1205 for clamping the optical fibers 1212, 1213. Thus, the clamp 1205 may translate with the stripping station 1216. The clamp 1205 may include an individual clamp for each optical fiber 1212, 1213, or may utilize a single shared clamp for both optical fibers 1212, 1213. The clamp 1205 may be engaged or disengaged during the preparation process, as will be discussed below. In an alternative embodiment where the optical fibers 1212, 1213 are translated instead of the stripping station 1216, the clamp 1205 may also be in a fixed position relative to the main body 1214 without need for the carriage 1215.

The unit 1200 may further include a cleaning station 1201, which may preferably be a “contactless” cleaning station 1201. This means that the cleaning station 1201 preferably cleans the optical fibers 1212, 1213 without physically rubbing or wiping the optical fibers 1212, 1213 at the portion to be cleaned. A contactless cleaning station 1201 reduces the risk of damage to stripped optical fibers during the cleaning process as compared with cleaners that physically rub or wipe the optical fibers. An example of such a contactless cleaning station 1201 is described below with regard to FIGS. 26-32. The cleaning station 1201 may translate relative to the main body 1214, and such translation may be transverse to the longitudinal axes of the optical fibers 1212, 1213. For example, the translation of the cleaning station 1201 may be perpendicular, or generally perpendicular (such as between 80 degrees and 110 degrees), with the longitudinal axes of the optical fibers 1212, 1213. One or more cleaning stations 1201 may be used. Where a single cleaning station 1201 is used, the single cleaning station 1201 may clean multiple optical fibers 1212, 1213 simultaneously (e.g., as shown in FIG. 15).

The unit 1200 may further include a cleaving station 1204, which may include any type of optical fiber cleaving device. The cleaving station 1204 may be translatable relative to the main body 1214, and such translation may be transverse to the translation directions of the stripping station 1216 and/or the cleaning station 1201. For example, the translation of the cleaving station 1204 may be perpendicular, or generally perpendicular (such as between 80 degrees and 110 degrees), with either or both of the translation directions of the stripping station 1205, 1206, 1207 and the cleaning station 1201. As a further example, where the main body 1214 is laying flat horizontally such that the view of FIG. 12 is a view from above, the longitudinal axes of the optical fibers 1212, 1213 may run horizontally between left and right, the stripping station 1216 may translate between left and right, the cleaning station 1201 may translate between back and front (i.e., between top and bottom of FIG. 12), and the cleaving station 1204 may translate between up and down (i.e., between up and down in FIG. 13). Further details of an exemplary embodiment of the cleaving station 1204 are discussed below.

The unit 1200 may further include a vacuum system 1210 for collecting the scrap optical fiber portions that are cleaved off the optical fibers 1212, 1213. The vacuum system 1210 may remain fixed in one place on the main body 1200 and/or some or all of the vacuum system 1210 may translate in any direction such as longitudinally with the optical fibers 1212, 1213. The vacuum system 1210 may include one or more hollow elongated plenum members 1208, 1209 for applying a vacuum to an area immediately adjacent to the optical fibers 1212, 1213. For instance, the elongated plenum members 1208, 1209 may apply the vacuum at or near the tips of the uncleaved optical fiber 1212, 1213, and/or immediately adjacent to a portion of the stripping station 1216. The vacuum system 1210 may provide any amount of vacuum in the elongated plenum members 1208, 1209 such as at least −0.5 atmosphere of vacuum pressure. Further details of an exemplary embodiment of the vacuum system 1210 are discussed below.

The optical fibers 1212, 1213 may be selectively removably coupled to the main body 1214 by optical fiber holders 1202, 1203. Such coupling and uncoupling may be automatic or may be manually activated. A single optical fiber holder may be used to clamp multiple optical fibers 1212, 1213 simultaneously, or each optical fiber 1212, 1213 may have its own dedicated optical fiber holder. The optical fiber holders 1202, 1203 may be any type of device such as a clamp that temporarily maintains the optical fibers 1212, 1213 in a fixed position relative to the main body 1214. The optical fiber holders 1202, 1203 may apply friction to the optical fibers 1212, 1213 using any known method in order to maintain their positions. In an alternative embodiment, the optical fiber holders 1202, 1203 may automatically or manually translate relative to the main body 1214, such as in a direction longitudinal with the axes of the optical fibers 1212, 1213. The optical fiber holders 1202, 1203 may further be manually or automatically adjustable to be disposed at a desired fixed position relative to the main body 1214.

Each of the stations, devices, and systems 1201-1210 of the unit 1200 may translate automatically or manually using any known method of power, such as by applying electrical, mechanical, hydraulic, and/or pneumatic power to the various stations and systems. The translation of the various stations, devices, and systems may be linear or may be nonlinear. In some embodiments, the translations of each of the stripping station 1216, the cleaning station 1201, and the cleaving station 1204 are all transverse to one another, or perpendicular to one another, or substantially perpendicular (e.g., 80 to 100 degrees) to one another. Translation of any of the moving part of the unit 1200 may occur along predefined tracks coupled to the main body 1214, and/or via robotic arms (coupled to the main body 1214) that translate or pivot. Also, the cleaning station 1201 and/or the cleaving station 1204 may move by pivoting instead of or in addition to translating.

The unit 1200 may include a control panel 1211 that may have one or more various displays and/or controls. The display may be a touch-sensitive liquid-crystal display or any other type of display. In one embodiment, the display may provide a different background color depending upon the status of the unit 1200. For example, the display may have a green background color when the unit is not presently operating on the optical fibers 1212, 1213 but ready to be operated, a red background color while the various stations, devices, and/or systems are in motion or operation or are about to be in motion or operation, and an orange background color when the unit 1200 such as the control panel 1211 requires user input or action. The display may present text and/or graphics indicating the status of the unit 1200, providing instructions to the user, and/or requesting input from the user.

Referring to FIG. 13, the unit 1200 may include a cover portion 1301 that covers some or all of the stations, devices, and systems 1201-1210, 1215, 1216. The cover portion 1301 may rest on (or be coupled to in any other manner) the main body 1214 to completely or partially cover the top of the main body 1214. The cover portion 1301 may be translucent, transparent, or opaque, and may be made of any material such as metal, plastic, or LEXAN. The cover portion 1301 may include one or more openings to receive the optical fibers 1212, 1213. The cover portion 1301 may be removable from the main body 1214 in order to service or prepare the unit 1200. While the unit 1200 is in operation, the cover portion 1301 may serve to protect the user from being injured by moving parts and to protect the optical fibers 1212, 1213 from being damaged by an external force.

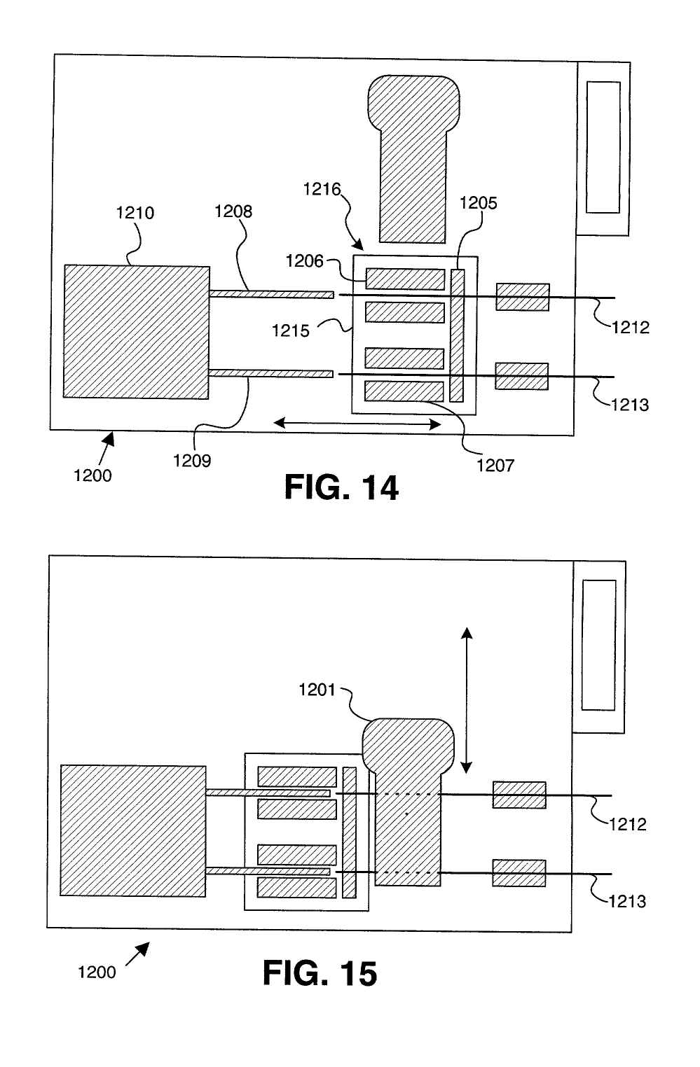

An exemplary operation of the unit 1200 is now described with reference to FIGS. 14-17. The optical fibers 1212, 1213 may be automatically or manually coupled to the optical fiber holders 1202, 1203. The clamps of the optical fiber holders 1202, 1203 may be automatically or manually engaged to hold the optical fibers 1212, 1213. Referring to FIG. 14, the carriage 1215 may translate the stripping station 1216 toward the optical fibers 1212, 1213 (in this case toward the right side of FIG. 14) and along their longitudinal axes such that the heaters of the stripping devices 1206, 1207 are proximate to the optical fibers 1212, 1213. The heaters 1206, 1207 heat the optical fibers to soften their outer layers. When the optical fibers 1212, 1213 are sufficiently heated, the blades of the stripping devices 1206, 1207 may move to engage with the outer layer(s) of the optical fiber 1212, 1213 prior to or while the carriage 1215 translates the stripping station 1216 back to the starting position (in this case toward the left side of FIG. 14). The act of translating to the starting position with the stripping blades engaged causes the outer layer(s) of the optical fibers 1212, 1213 to be stripped. Thus, the blades strip the optical fibers 1212, 1213 from the point of engagement with the optical fibers to the ends of the optical fibers. The portion stripped is referred to herein as the stripped portion of each of the optical fibers 1212, 1213. The stripped portion may be any length such as, e.g., at least 2 inches. At this point, the vacuum system 1210 may apply a vacuum to collect the scrap stripped portions of the optical fibers 1212, 1213 via the elongated plenum members 1208, 1209. During the entire stripping process, the optical fibers 1212, 1213 may remain stationary with respect to the main body 1214. Alternatively, the optical fibers 1212, 1213 may translate toward the stripping station 1216 along their longitudinal axes while the stripping station 1216 also translates toward the optical fibers 1212, 1213, or instead of the stripping station 1216 translating at all. In the latter case, stripping would occur when the optical fibers 1212, 1213 translate back to their starting positions and the blades of the stripping devices 1206, 1207 are engaged. Preferably, in any of these embodiments, the clamp 1205 is disengaged during the stripping process to allow the optical fibers 1212, 1213 to travel freely through the clamp 1205 (or to allow the clamp 1205 to travel freely along the optical fibers 1212, 1213).

Referring to FIG. 15, once the optical fibers 1212, 1213 are stripped, the cleaning station 1201 may translate inward toward the optical fibers 1212, 1213 as shown (i.e., down in FIG. 15). At least some of the stripped portions of the optical fibers 1212, 1213 may be cleaned, and the cleaning station 1201 may then translate back to the starting point (i.e., up in FIG. 15). Preferably, the cleaning station 1201 cleans a portion of each of the optical fibers 1212, 1213 that is less than the stripped portions. This is because a portion of the stripped portion of each optical fiber 1212, 1213 will later be cleaved off, and cleaning the portion to be cleaved off is a waste of cleaning fluid and may require a larger cleaning station 1201. However, any length of the optical fibers 1212, 1213 may be cleaned as desired. During the cleaning process, the clamp 1205 may be either engaged or disengaged.

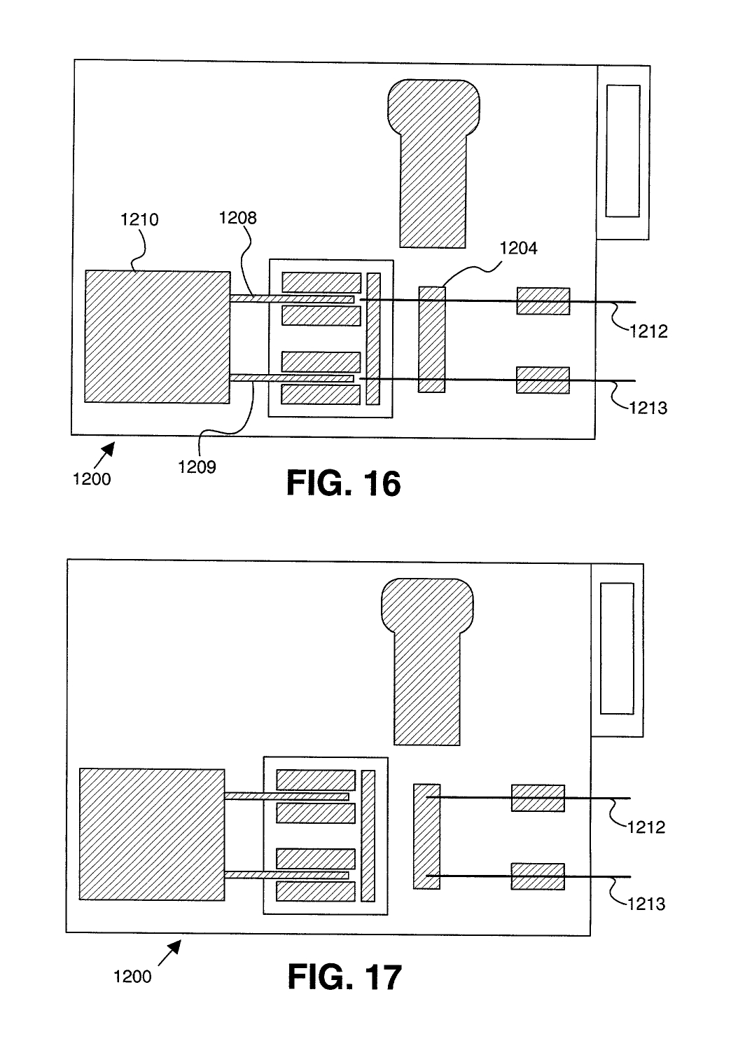

Referring to FIG. 16, once the optical fibers 1212, 1213 are stripped and cleaned, the cleaving station 1204 may translate toward the optical fibers 1212, 1213 to cleave them. During the cleaving process, the clamp 1205 preferably engages to clamp the optical fibers 1212, 1213 and thereby provide a longitudinal tension on the optical fibers 1212, 1213 between the stripping device and the optical fiber holders 1202, 1203. Such longitudinal tension may result in a higher-quality cleave. The tension may be, e.g., between 150 and 250 grams of force, such as 200 grams. After the optical fibers 1212, 1213 are cleaved, the cleaving station 1204 may translate to withdraw back to the starting point. The vacuum system 1210 may apply a vacuum to collect the scrap cleaved portions of the optical fibers 1212, 1213 therewithin. To allow the vacuum system 1210 to collect the scrap, the clamp 1205 may disengage from the scrap portions of the optical fibers 1212, 1213.

FIG. 17 illustrates the state of the unit 1200 and the optical fibers 1212, 1213 after the stripping, cleaning, and cleaving are completed and the various stations 1201, 1204, 1216 are in their starting positions. At this point, the optical fibers 1212, 1213 are ready to be spliced, either together or with other optical fibers. Splicing may be done by removing the optical fibers 1212, 1213 from the unit 1200 and using a splicing device (not shown). The splicing device may be separate from the unit 1200 or may be coupled to the unit 1200.

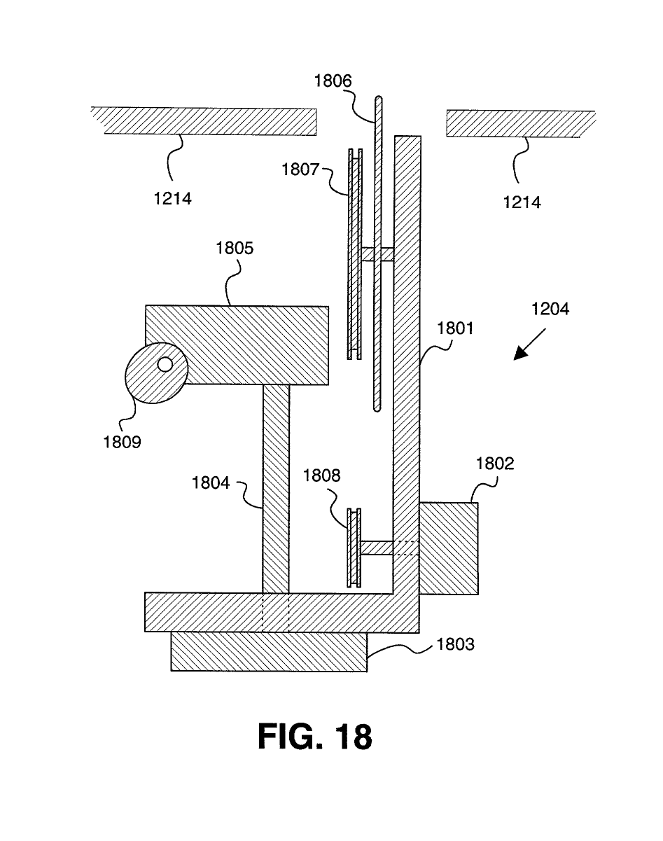

Details of an exemplary embodiment of the cleaving station 1204 are now discussed with reference to FIG. 18. A substantial portion of the cleaving station 1204 may be disposed within a hollow portion of the main body 1214, although this is not necessary. In the illustrated example, the cleaving station 1204 is disposed substantially under an upper surface of the main body 1214 and translates through an opening in the upper surface of the main body 1214. The cleaving station 1204 may include a fixed body 1803, 1804, 1805 and a moveable body 1801 that translates relative to the fixed body. The fixed body 1803-1805 may include a base 1803, a track 1804, and/or an upper portion 1805. The fixed body 1803-1805 may be coupled to a rotatable cam 1809. Alternatively, the cam 1809 may be replaced with an arm, lever, or other similar device.

The moveable body 1801 may be a carriage that translates along the track 1804 of the fixed body (in this example, up and down in FIG. 18). The moveable body 1801 may include or be coupled to a motor 1802, which may be, e.g., electric, pneumatic, or hydraulic. The motor 1802 may spin a first wheel 1808 (which may also be a gear). The first wheel 1808 may cause a second wheel 1807 coupled to the moveable body to spin, such as by a belt (not shown) or through gear teeth action. The second wheel 1807 may be fixedly or otherwise coupled to a cleaving disk 1806, thereby causing the cleaving disk 1806 to spin. Any combination of mechanics and/or other devices may be used to cause the cleaving disk 1806 to spin. For instance, the cleaving disk 1806 may be directly connected to a motor. Also, in alternative embodiments, the cleaving disk 1806 may instead a type of cleaving device other than a spinning cleaving edge, such as an oscillating straight saw edge. Also, the cleaving station 1204 may include dual cleaving edges on opposing sides of the optical fibers 1212, 1213.

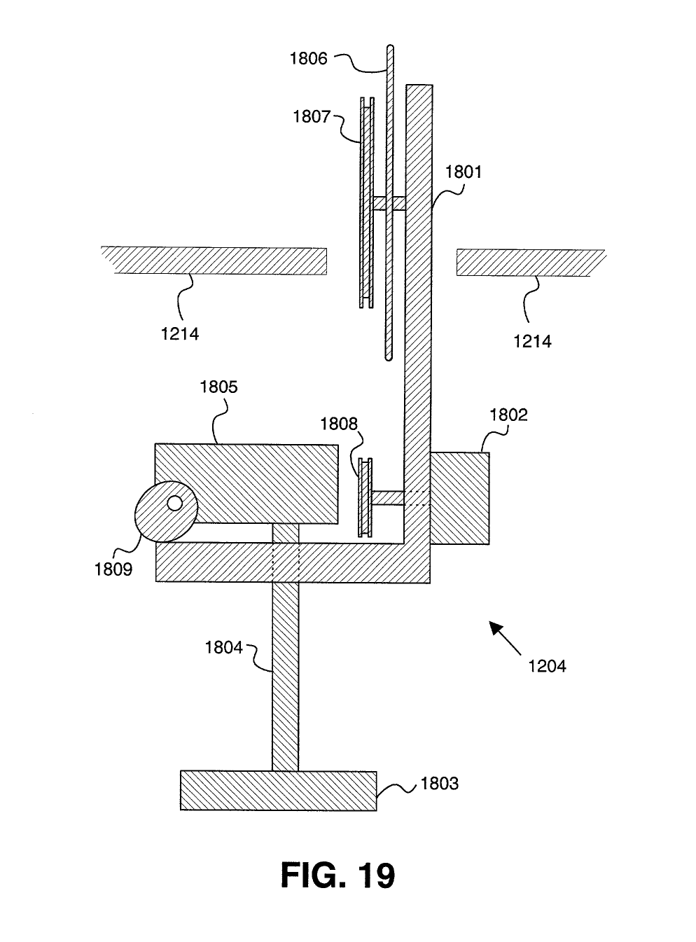

Referring to FIG. 19, the moveable body 1801 may translate along the track 1804 at a first velocity, thereby translating the cleaving disk 1806 upward (in this example) through the upper surface of the main body 1214 toward the optical fibers 1212, 1213. The moveable body 1801 may be caused to translate via any means such as using a pneumatic activator. A constant or varied force (e.g., from the pneumatic activator) may move the moveable body 1801 upward (or otherwise inward toward the optical fibers 1212, 1213) until it contacts the cam 1809. At this point, preferably, the cleaving disk 1806 is spinning, but the cleaving disk 1806 has not yet touched the optical fibers 1212, 1213. Since the cleaving disk 1806 has not yet physically touched the optical fibers 1212, 1213, the velocity of the moveable body 1801 at this phase is not critical and should not affect the quality of the cleave. Thus, the moveable body 1801 may be caused to translate relatively quickly, such as at least 2 centimeters per second.

The speed at which the cleaving disk approaches and physically contacts the optical fibers 1212, 1213, however, is more critical to the quality of the resulting cleave. The cam 1809 may be utilized to control the speed of the moveable body 1801 as the optical fibers 1212, 1213 are approached by the cleaving disk. At the point the moveable body 1801 contacts the cam 1809, the cleaving disk 1806 may be some distance away from the optical fibers 1212, 1213, such as 0.5 millimeters (as shown in FIG. 22, in which a single cleaving disk cleaves at least two optical fibers simultaneously or substantially simultaneously), or between 0.01 and 2 millimeters, or between 0.001 and 10 millimeters, away from contacting the optical fibers 1212,1213. In this regard, the cleaving disk 1806 is considered to cleave multiple optical fibers substantially simultaneously where the cleaving edge of the cleaving disk 1806 is in simultaneous physical contact with all of the multiple optical fibers at a particular point in time. The cam 1809 may be designed to resistively allow the moveable body 1801 to translate such that the cleaving disk 1806 approaches and contacts the optical fibers 1212, 1213 at a second velocity lower than the first velocity. In other words, the moveable body 1801 may be cause to move upwardly by, e.g., a pneumatic activator, and may experience resistive pressure in the opposite downward direction by the cam 1809. To provide the resistive pressure against the upward force (e.g., from the pneumatic activator), the cam 1809 may be powered by another motor, be coupled to a pneumatic or hydraulic piston or other activator, and/or be coupled to a spring (all not shown). Where the cam 1809 is coupled to a motor, the cam 1809 may be caused to rotate at a fixed or varied speed.

As already mentioned, the cleaving disk 1806 may cleave two or more physically separate and apart optical fibers 1212, 1213 simultaneously or substantially simultaneously. Referring still to FIG. 22, in such an embodiment, the angle 0 between each of the plurality of optical fibers (as measured from the axis of rotation of the cleaving disk 1806) during cleaving may be of any angle. In preferred embodiments, the angle Ø is at least 10 degrees, or even at least 30 degrees.

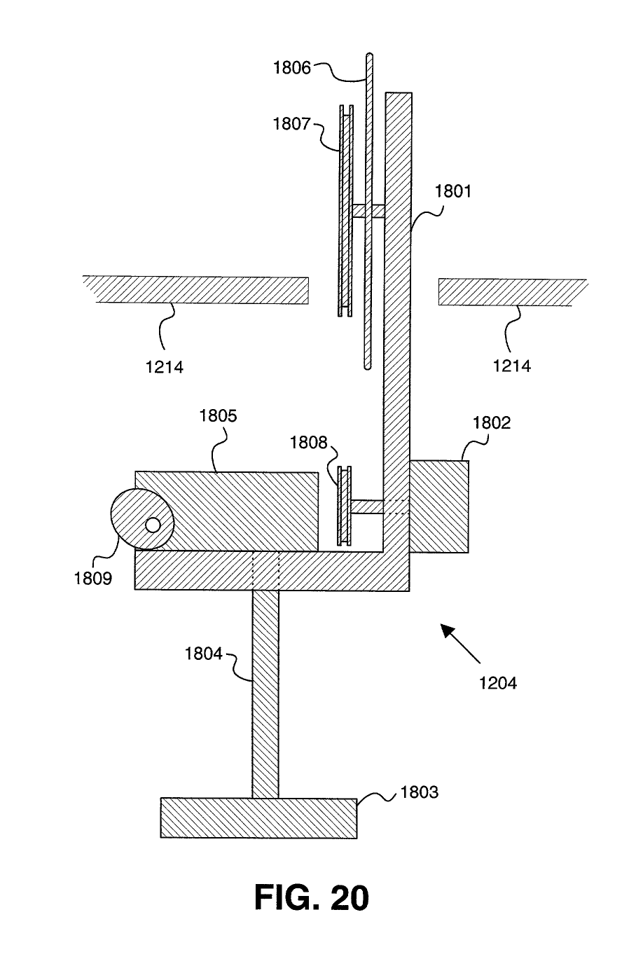

Referring to FIG. 20, the cam 1809 may have sufficient resistive pressure and/or sufficient independent movement to allow the moveable body 1801 to approach and contact the optical fibers 1212, 1213 at the second velocity. In some embodiments, the second velocity may be less than 0.2 millimeter per second. A second velocity of about 0.05 millimeters per second, or between 0.04 and 0.06 millimeters per second, or between 0.01 and 0.1 millimeters per second, works well to produce a quality cleave in an optical fiber. The rotary speed of the cleaving disk 1806 also affect the quality of the resulting cleave. Although the rotary speed of the cleaving disk 1806 may be of any speed, a speed of between 700 and 900 rotations per minute, or of 800 rotations per minute, produces a high-quality cleave.

The cleaving disk 1806 may cut all the way through the optical fibers 1212, 1213, or may merely inscribe the outer surface of the optical fibers 1212, 1213 to cause a surface defect without cutting all the way through the optical fibers. Where the outer surface is inscribed, longitudinal tension (previously discussed) applied to the optical fibers 1212, 1213 by the unit 1200 causes the optical fibers to cleave at the location of the surface defect.

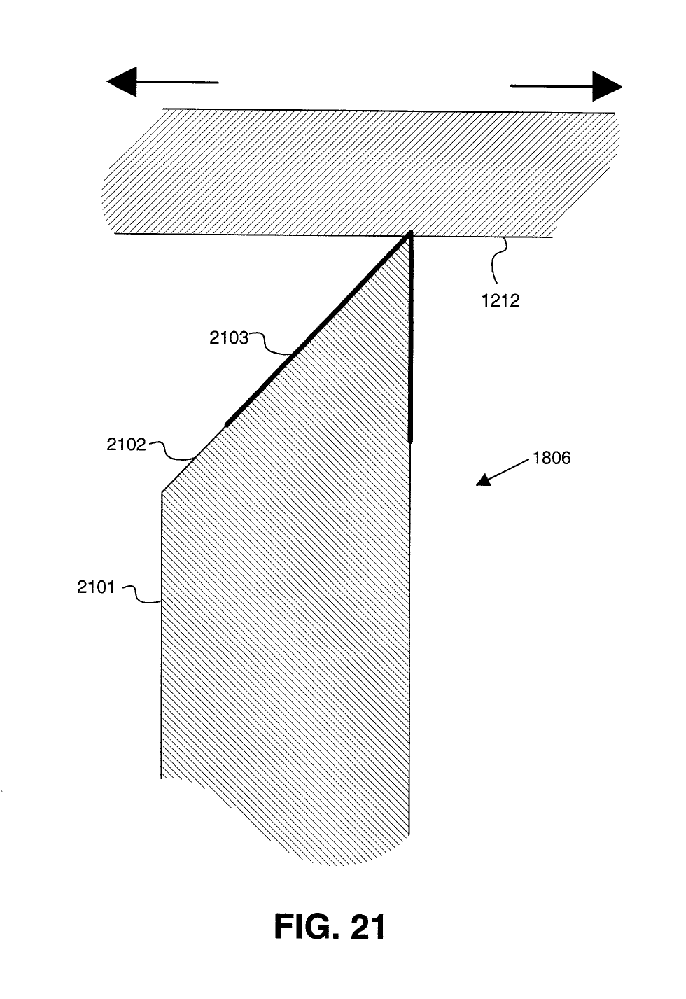

Referring to FIG. 21, the cleaving disk 1806 may have an inner circular portion 2101, a beveled portion 2102 disposed circumferentially around the inner circular portion, and/or a cutting layer 2103 disposed circumferentially on at least the beveled portion 2102. The cutting layer 2103 is preferably of a hard material such as diamond, but may be of any material. The inner circular portion 2101 and the beveled portion 2102 may be made of any material such as aluminum or plastic. The beveled portion may be of any length and bevel angle. In one embodiment, the beveled portion 2102 is, at its widest portion, about 6 microns, and is 0.5 millimeters in diametric length. Preferably, the beveled portion is at least as long in diametric length as the optical fibers 1212, 1213 are in width.

Preferably, the beveled portion 2101 is edge-beveled, that is, beveled only on a single side and flat on the other side, as shown in FIG. 21. However, the beveled portion 2101 may alternatively be center-beveled or have an offset bevel. Where the beveled portion is edge-beveled, the beveled side (left side of FIG. 21) preferably faces the portions of the optical fibers 1212, 1213 to be cleaved away (i.e., the scrap portions) and the flat side (right side of FIG. 21) faces the remaining portions of the optical fibers 1212, 1213. This is advantageous because when the optical fibers 1212, 1213 are cleaved under tension, the remaining portions of the optical fibers 1212, 1213 naturally retract slightly when the tension is suddenly released due to cleaving. The remaining portions of the optical fibers 1212, 1213, upon retracting, would not touch the cleaving disk 1806 after cleaving.

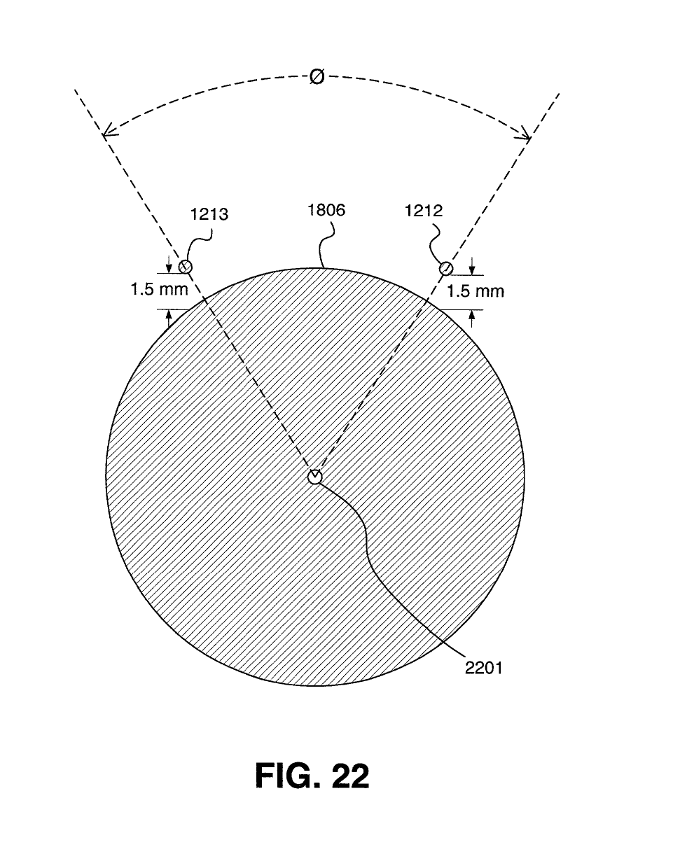

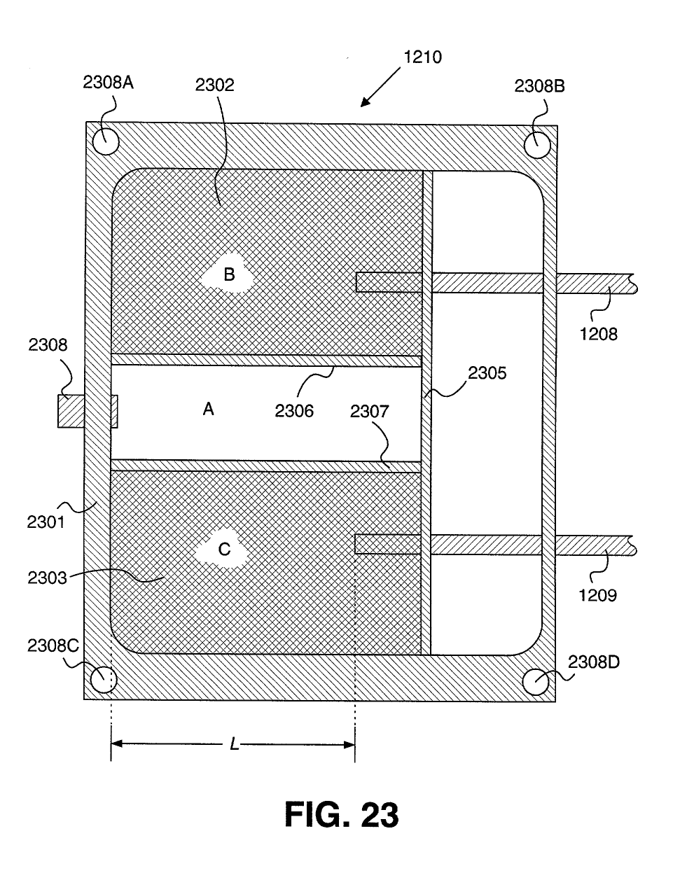

The detailed structure and operation of an exemplary embodiment of the vacuum system 1210 is now discussed with reference to FIGS. 23-25. The vacuum system 1210 may include a housing that may be divided by walls to define a plurality of plenums. The housing may be made of any material such as aluminum or plastic and may preferably be airtight with the exception of various air input and output ports. The housing may include a base portion 2301 and/or a cover portion 2401 removable from the base portion 2301. The cover portion 2401 may be attached in an airtight manner via screws or bolts into threaded holes 2308A-D. A seal or gasket may be utilized between the cover portion 2401 and the base portion 2301 to improve the airtight seal between them. The cover portion 2401 may be removed in order to access and discard scrap that has collected within the vacuum system 1210.

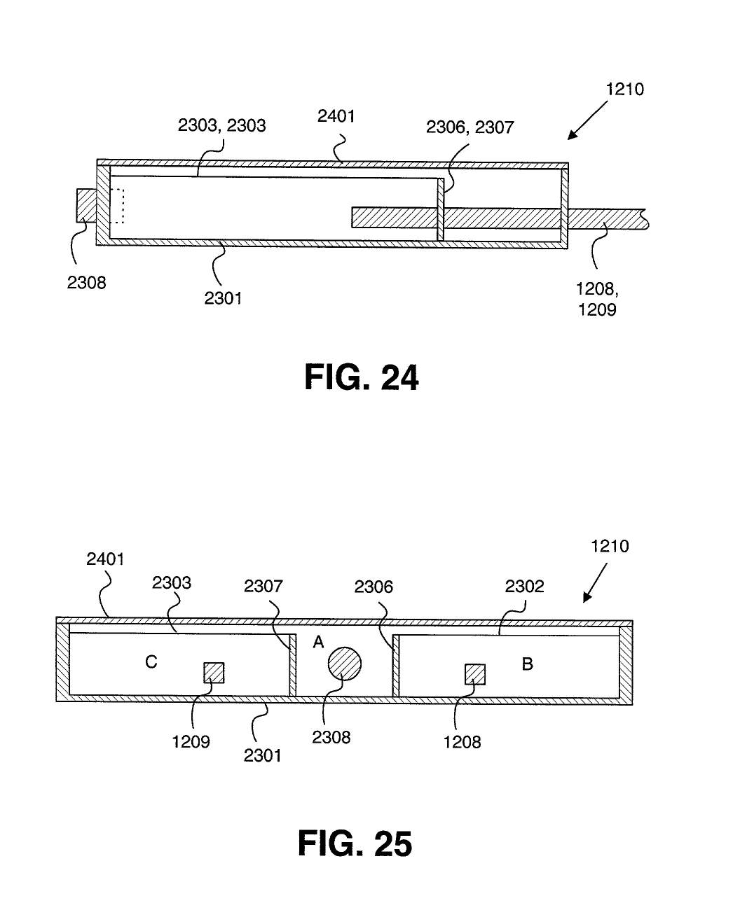

The base portion 2301 may include various walls such as wall 2305, wall 2306, and wall 2307. These walls may define a plurality of plenums, in this case three: plenums A, B, and C. Plenum A in the illustrated embodiment is used to receive the vacuum from an air output port 2308. The air output port 2308 may be coupled to a vacuum device that applies a vacuum to the air output port 2308. Plenums B and C each have a screen 2302, 2303 or other material that allows the passage of air, such as a grill or mesh, while preventing scrap from passing out of plenums B and C into plenum A. As can be seen from FIGS. 23 and 24, plenum A is thus coupled to plenums B and C such that any vacuum applied to plenum A also passes into plenums B and C through the screens 2302,2303. The screens 2302,2303 may also be removable for removing and discarding any scrap optical fibers and/or scrap stripped optical fiber layers that have collected within plenums B and C.

Each of the plenums B and C may be coupled to the elongated plenum members 1208, 1209 discussed previously. Thus, any vacuum applied to plenums B and C may be passed on to the respective elongated plenum members 1208, 1209. The elongated plenum members 1208, 1209 may be adjustably extensible using any known arrangement. The relatively large surface area of the screens 2302, 2303 and partial walls 2306, 2307 allow for the vacuum to pass between the plenums A and B, and between the plenums A and C, without being clogged by the accumulation of scrap portions of the optical fibers 1212, 1213. Also, each of the plenums B and C are preferably at least as long L as the length of the scrap portions of the optical fibers 1212, 1213 that are cleaved off. This allows for the scrap to accumulate in the plenums B and C while reducing the possibility of clogging the plenums B and C or the elongated plenum members 1208, 1209. In an alternative embodiment, plenums B and C may be a single common plenum separated by a partial wall (such as wall 2306) from the plenum A. In such an alternative embodiment, the two elongated plenum members 1208, 1209 may both couple into the single common plenum. Where only a single optical fiber (e.g., optical fiber 1212) is being processed at a time, the vacuum system 1210 may have only plenums A and B. In still further alternative embodiments, the physical relative locations of the plenums A, B, and C may be different than as shown in FIG. 23. For instance, plenums B and C may be disposed next to each other, while plenum A is disposed to one or the other side of plenums B and C. Or, plenum A may be behind or in front of (e.g., in FIG. 23, to the left or right of) plenums B and/or C. Or, for instance, plenum A may be above or below plenums A and/or B.

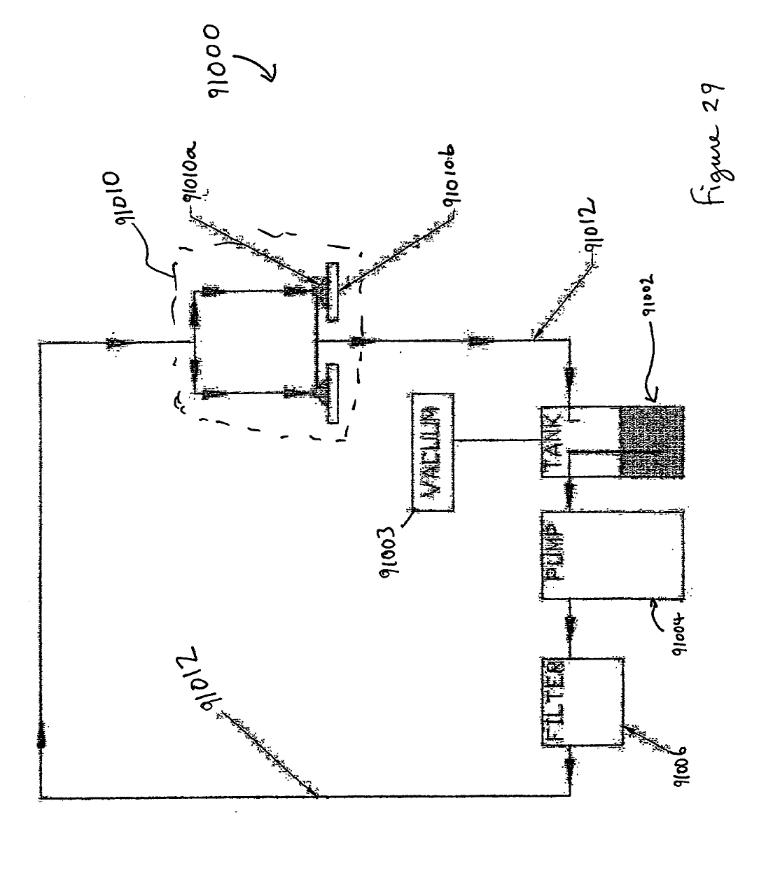

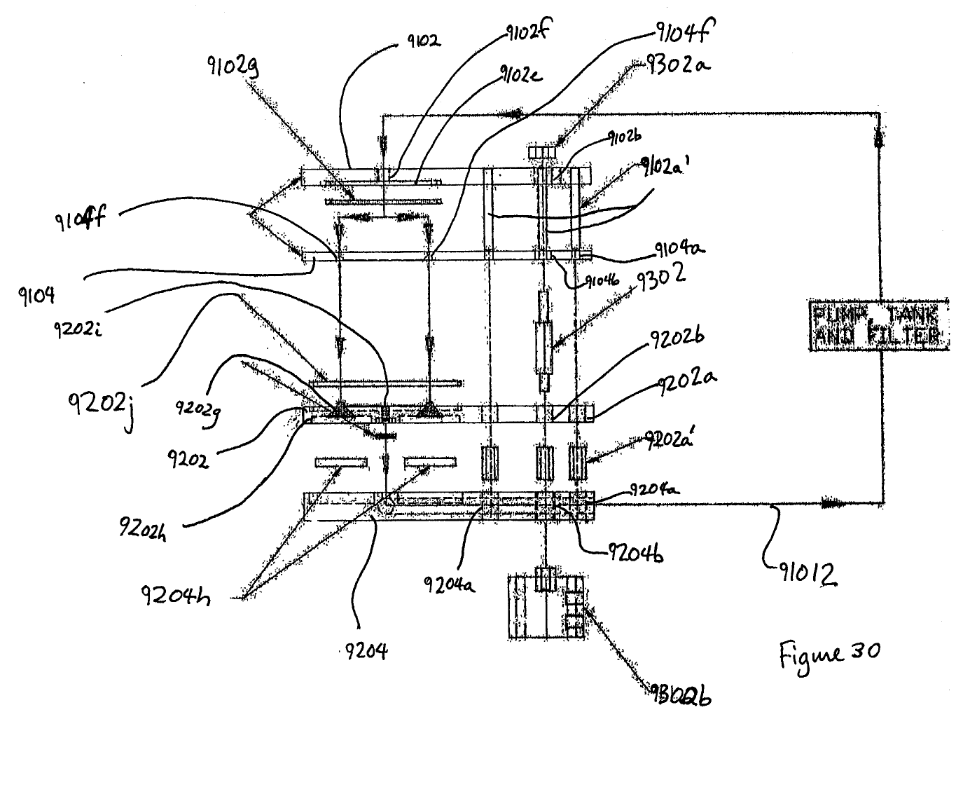

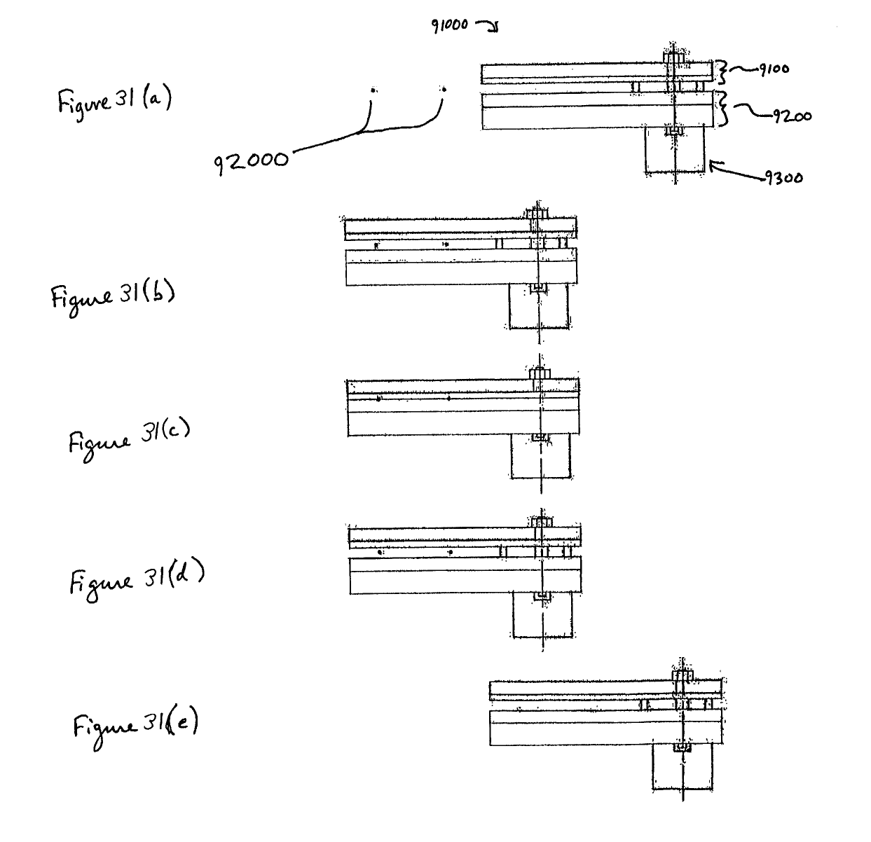

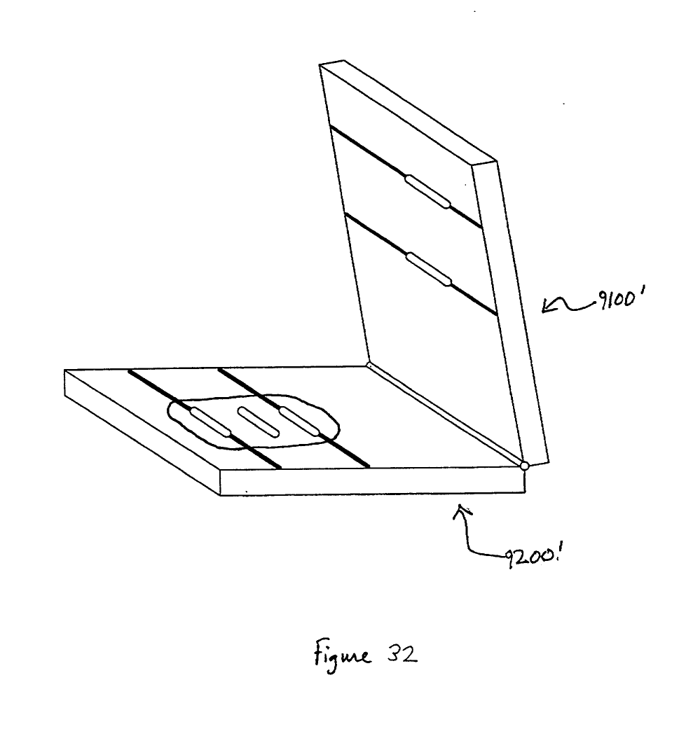

Referring to FIGS. 31(a)-31(e), the cleaning station 1201 may be embodied as a contactless cleaning apparatus 91000 that includes first chamber part 9100 and second chamber part 9200. First and second chamber parts 9100, 9200 are selectively movable relative to each other between open and closed states, and together (in their closed state) at least partly define a cleaning chamber according to the present invention (described in more detail below).

In one example of the present invention, first and second chamber parts 9100, 9200 are independent members. In this case, cleaning apparatus 91000 may include an appropriately constructed actuator mechanism 9300 for selectively moving the first and second chamber parts 9100, 9200 relative to each other between open and closed states. One example of an actuator mechanism is a conventional pneumatically-actuated push-pull rod actuator 9302 that operates to selectively pull together first and second chamber parts 9100, 9200 to closed state and to selectively push them apart to an open state.

In another example of the present invention generally illustrated in FIG. 32, first and second chamber parts 9100′, 9200′ may be hingedly attached to each other instead of being independent parts. A suitable actuator mechanism (not shown) may be used with that arrangement as well to hingedly move the first and second chamber parts 9100′, 9200′ into and out of opposition with each other.

The first chamber part 9100 and the second chamber part 9200 each may be made from a plurality of joined constituent parts. For example, FIG. 26(a) illustrates a first constituent part 9102 of first chamber part 9100, and FIGS. 26(b) and 26(b) illustrate opposite faces of a second constituent part 9104 of first chamber part 9100.

As seen in FIGS. 26(a)-26(c), constituent parts 9102 and 9104 are similarly shaped in plan and are fixed together using fastening members (such as, without limitation, bolts, screws, and rivets) passed through fastening holes 9102c, 9104c, respectively. The side of constituent part 9104 shown in FIG. 26(b) opposes the side of constituent part 9102 shown in FIG. 26(a) when constituent parts 9102, 9104 are fixed together. Parts 9102, 9104 each include, respectively, an actuator bore 9102b, 9104b through which push-pull actuator 9302 passes, and dowel holes 9102a, 9104a in which alignment dowels 9102a′ are mounted. The alignment dowels 9102a′ outwardly extend from first chamber part 9100 from the side of constituent part 9104 shown in FIG. 26(c).

Constituent part 9102 includes an elongate trench 9102e formed therein. For example, constituent part 9102 may be made from a metallic material, and trench 9102e may be formed therein by milling or the like. Trench 9102e includes at least one fluid port 9102f extending through the thickness of constituent part 9102. Preferably, a sealing member 9102g is provided about a periphery of trench 9102e, such as a resilient sealing ring mounted in a peripheral groove extending about a periphery of trench 9102e. The sealing member 9102g is preferably made from a resilient material, such as VYTON™, that resists chemical reaction with a cleaning fluid used in the apparatus.

When constituent parts 9102 and 9104 are fixed together, trench 9102e is aligned with the at least one fluid port 9104e extending through the thickness of constituent part 9104. In a desirable arrangement according to an embodiment of the present invention, one fluid port 9102f and a number of fluid ports 9104e corresponding to the number of cleaning chambers present are provided. Trench 9102e with fluid port 9102f formed therein desirably provides a single fluid input point for feeding a cleaning fluid into the apparatus, thereby simplify the construction and operation of the apparatus. The cleaning fluid fed through fluid port 9102f is distributed to the at least one fluid port 9104e because trench 9102e extends so as to be in communication with all of the fluid ports 9104e provided. It will therefore be appreciated that the length of trench 9102e corresponds to the number of fluid ports 9104e provided in constituent part 9104. The sealing member 9102g provided around trench 9102e helps to prevent cleaning fluid from leaking out of trench 9102e between constituent parts 9102, 9104.

The side of constituent part 9104 shown in FIG. 26(c) includes at least one cleaning chamber trench 9104f in which a corresponding fluid port 9104e (discussed above) is located. The number of cleaning chamber trenches 9104f provided in the apparatus corresponds to the number of cleaning chambers provided in the apparatus. If more than one cleaning chamber trench 9104f is provided, each cleaning chamber trench 9104f is generally parallel to the other cleaning chamber trenches 9104f. Preferably, the cleaning chamber trenches 9104f are spaced apart from each other so as to not interfere with each other during processing. In one example of the present invention, two cleaning chamber trenches 9104f are provided.

Each cleaning chamber trench 9104f includes alignment grooves 9104g extending from opposite ends of the cleaning chamber trench 9104f, in line with cleaning chamber trench 9104f. The alignment grooves 9104g are sized so as to be able to receive an optical fiber being cleaned therein, and they extend from a respective cleaning chamber trench 9104f to an edge of first chamber part 9100. The provision of alignment grooves 9104g running continuously with cleaning chamber trench 9104f helps to protect an elongate member being cleaned, such as an optical fiber, from being crushed between respective opposing faces of the fust and second chamber parts 9102, 9104.

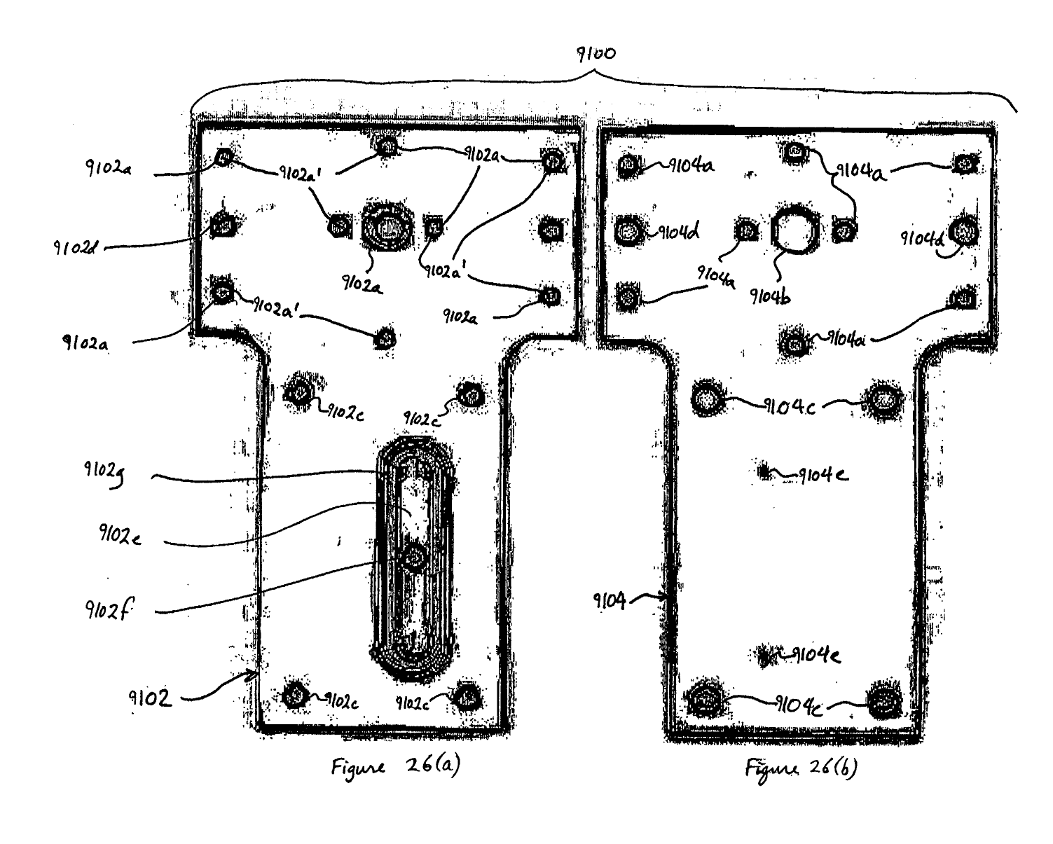

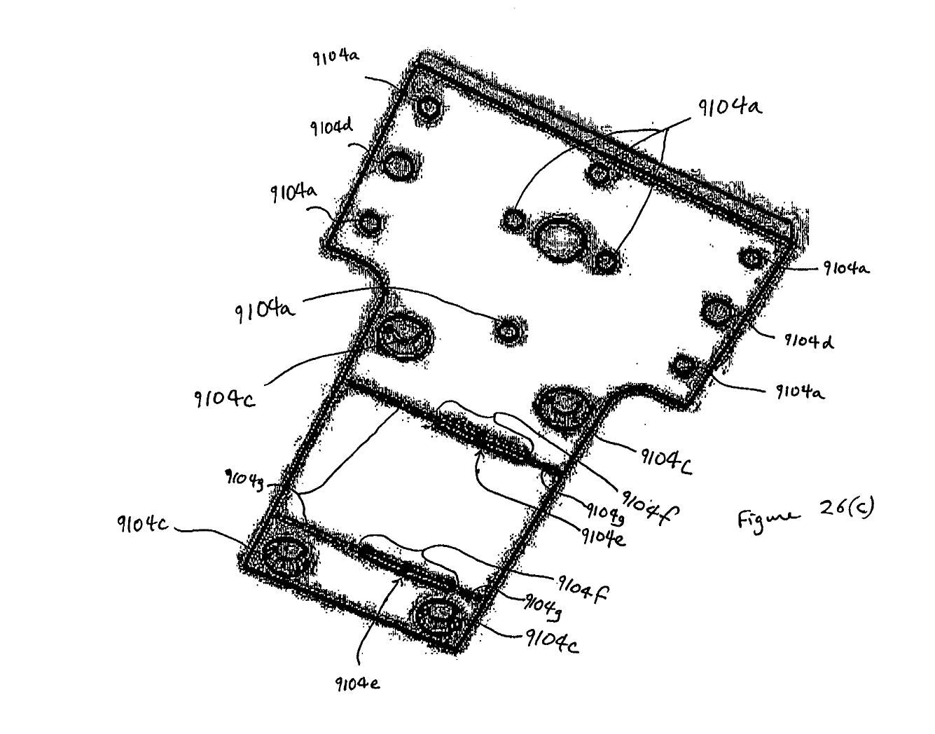

FIG. 27(a) illustrates a side of second chamber part 9200 that faces the side of first chamber part 9100 illustrated in FIG. 26(c). Second chamber part 9200 may also consist of constituent components, such as constituent components 9202, 9204, as seen in FIGS. 27(a), 27(b), and 28. FIGS. 27(a) and 27(b) illustrate opposite sides of constituent part 9202, and FIG. 28 illustrates a side of constituent part 9204 that faces the side of constituent part 9202 illustrated in FIG. 27(b) when constituent parts 9202, 9204 are fixed together (for example, using bolts, nuts or the like 9202c that pass through fastening holes 9202d and 9204d, respectively.

The constituent parts 9202, 9204 include actuator bores 9202b, 9204b formed therethrough, corresponding to actuator bores 9102b, 9104b formed in first chamber part 9100. The constituent parts 9202, 9204 also include dowel holes 9202a, 9204a formed therethrough, aligned with dowel holes 9102a, 9104a in first chamber part 9100. As can be seen in FIGS. 27(a) and 27(b), dowel holes 9202a may include conventional sleeve bearings 9202a′ or the like therein to facilitate travel of second chamber part 9200 on dowels 9102a′.

Constituent part 9202 includes a cleaning chamber slit 9202f formed therein, substantially corresponding in size and location to the cleaning chamber trench 9104f formed in first chamber part 9100. As seen in FIG. 27(b), a concavity 9202g is formed in the opposite side of constituent part 9202 in a location corresponding to cleaning chamber slit 9202f. In use, therefore, cleaning fluid supplied via cleaning chamber trench 9104f passes through cleaning chamber slit 9202f when cleaning chamber trench 9104f and cleaning chamber slit 9202f are in opposition. As a result, a quantity of cleaning fluid is held in the space defined by concavity 9202g.

A resilient sealing member 9202j is provided around a region including cleaning chamber slit 9202f and fluid outlet slit 9202i. For example, a resilient sealing ring or the like may be disposed in a groove or the like formed in constituent part 9202 as illustrated in FIG. 27(a).

The concavity 9202g is located in a region 9202h. The region 9202h corresponds to a corresponding ultrasonic transducer 9204h, that is powered by a conventional power source. Transducer 9204h may, for example, include an oscillating disc. Preferably, transducer 9204h is driven in oscillation so as to cause cavitation in the cleaning fluid, whereby small bubbles that enhance the cleaning action are formed. In the regard, the transducer 9204h is operable at frequencies between about 40 kHz and about 200 kHz.

In an alternative arrangement, one ultrasonic transducer may be provided to act on a plurality of cleaning chambers.

However, it is desirable to drive the transducer 9204h at a resonance frequency of the oscillating disc for the sake of efficiency. The oscillating disc may have a radial mode of vibration and a thickness mode. A 20 mm diameter disc, for example, may be driven in its radial mode at about 103 kHz. Different diameter discs, of course, will have different resonant frequencies, determinable according to known principles of physics. Power cable 9204e supplies electrical power to the transducer 9204h.

A fluid outlet port 9204i is provided in constituent part 9204, for example. Fluid outlet port 9204i is connected to a pump and/or a vacuum device, as described in more detail below. Fluid outlet port 9204i is in substantially sealed communication with fluid outlet slit 9202i in constituent part 9202. The provision of a single fluid outlet port from the apparatus is advantageous because multiple fluid output lines can be avoided. A sealing member 9202i′ may be provided about a periphery of fluid outlet slit 9202i in order to help prevent cleaning fluid from leaking between fluid outlet slit 9202i and fluid outlet port 9204i between constituent parts 9202, 9204.

Accordingly, cleaning fluid is drawn into fluid outlet slit 9202i substantially only from the region between first and second chamber parts 9100, 9200 defined by resilient sealing member 9202j, as seen in FIG. 27(a). It is not necessary, according to the present invention, to completely prevent cleaning fluid from leaking between first and second chamber parts 9100, 9200, but it is relatively more desirable to limit such leakage.

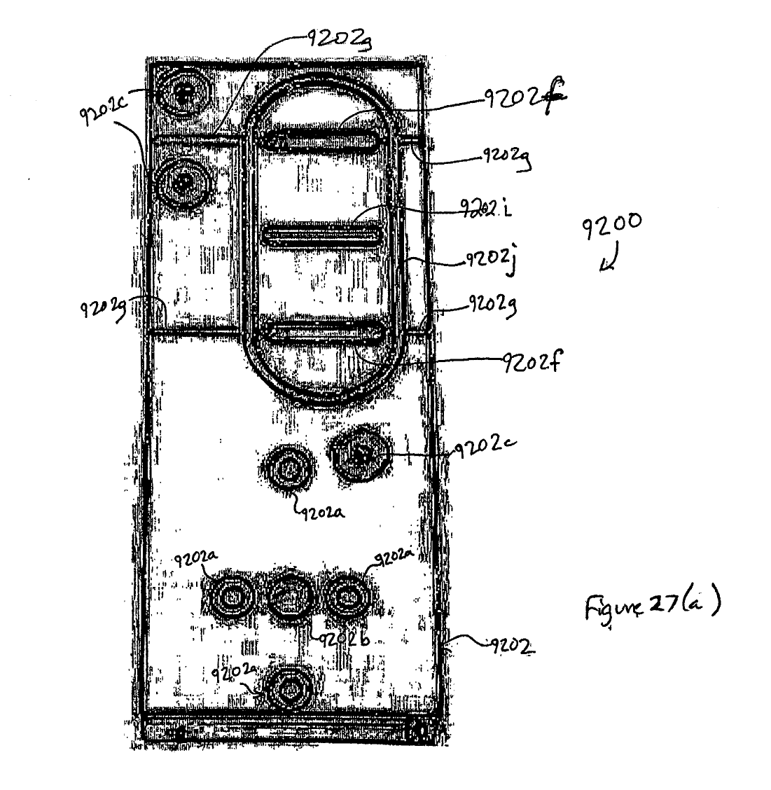

FIG. 29 is a schematic representation of cleaning apparatus 91000. In this example, cleaning fluid is moved in a closed circuit so as to be recycled. Thus, the apparatus 91000 may include a cleaning fluid supply tank 91002 containing a quantity of a cleaning fluid. Examples of cleaning fluids usable according to the present invention include, without limitation, isopropyl alcohol, methyl alcohol, ethyl alcohol, and acetone. About 500 ml of cleaning fluid are present in the system in a typical arrangement. In some cases, it may be useful (although not necessary) to provide a desiccant, such as anhydrous silica gel in the tank to absorb any water present in the system.

A fluid pump 91004 is also arranged in the circuit so as to move the cleaning fluid through the circuit. A conventional fluid pump can used according to the present invention. In a working example of the present invention, a 12 volt DC motor with a 20 psi output is used.

In addition, a vacuum device 91003 may be provided in the circuit, if desired. Vacuum device 91003 may be used to provide a slight vacuum in the circuit to further urge the cleaning fluid therethrough. In addition, a vacuum applied to the space between first and second chamber parts 9100, 9200 that is substantially sealed by sealing member 9202j helps to retard leakage and increase the drawing of cleaning fluid into fluid outlet slit 9202i.

Because the cleaning fluid is recycled, it is useful but not necessary to provide a conventional fluid filter apparatus 91006 in the circuit to filter the cleaning fluid before it is used in a new cleaning process. Filter 91006 may be a small-pore filter, such as a TEFLON™ membrane filter with, for example, a 0.2 micron pore size.

The portion of the apparatus in FIG. 29 indicated by a broken line box 91010 schematically represents the apparatus illustrated with reference to FIGS. 26-28, 30, and 31 and described in detail herein. It generally illustrates an example of a cleaning fluid supply being split between multiple (here, 2) cleaning chambers according to the present invention. The representation at 91010a represents the volume of cleaning fluid held in concavities 9202g (see, for example, FIG. 27(b)), driven to oscillate by schematically illustrated transducers 91010b.

The elements of the apparatus, such as tank 91002, pump 91004, filter 91006, and fluid lines 91012 are generally made of materials that are non-reactive or otherwise chemically resistant to the cleaning fluid being used. For example, tank 91002 may be lined with TEFLON™ and tank 91002 may be made from an appropriate polypropylene composition. Fluid lines 91012 may be made from, for example, VYTON™.

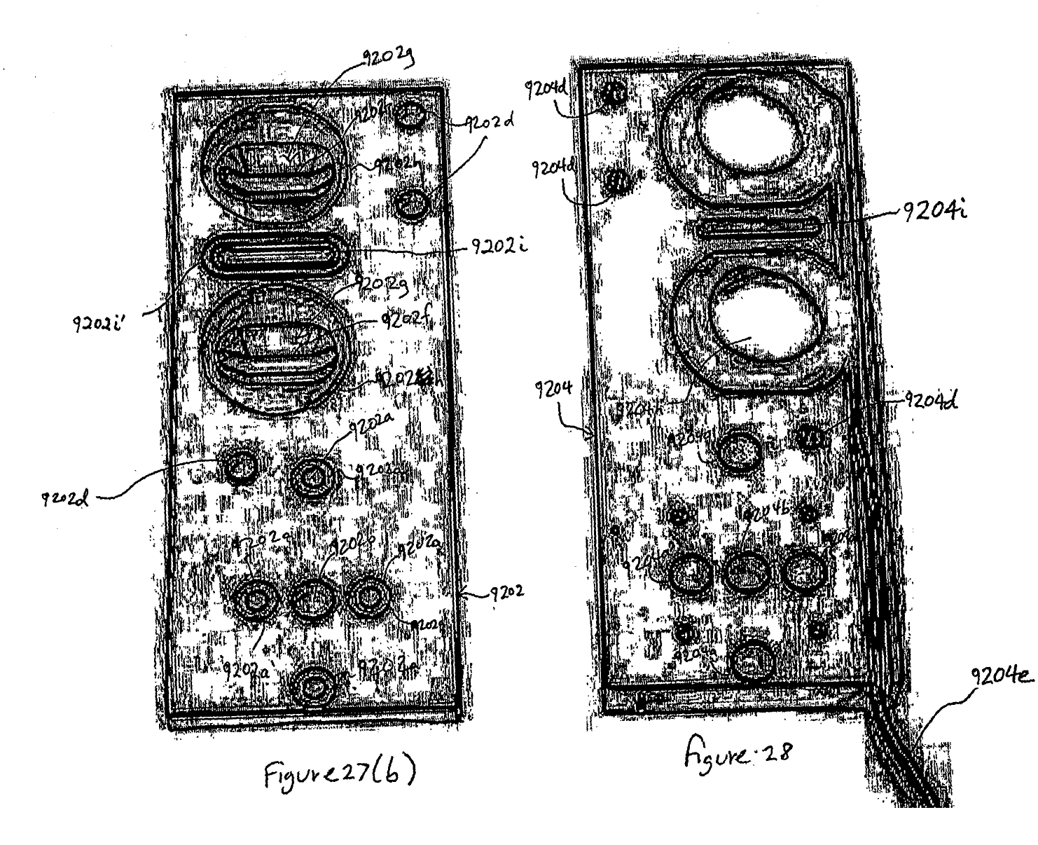

FIG. 30 is an exploded view illustrating the structures illustrated in FIGS. 26-29 and described hereinabove. Corresponding features discussed elsewhere herein are given the same reference numeral, and a detailed description thereof is not repeated.

The structure of an exemplary actuator mechanism can be more clearly seen in FIG. 30. Specifically, a push-pull rod 9302 is passed through actuatorbores 9102b, 9104b in first chamber part 9100, and through actuator bores 9202b, 9204b in second chamber part 9200. A distal end of push-pull rod 9302 is fixed against first chamber part 100 by a threaded nut or the like 9302a fixed to push-pull rod 9302. A proximal end of push-pull rod 9302 is connected to an actuator drive, such as a pneumatic source 9302b.

FIGS. 31(a)-31(e) illustrate an example operation of apparatus 91000. As seen in FIG. 31(a), a pair of elongate members 92000, such as optical fibers, are provided. In FIGS. 31(a)-31(e), the elongate members 92000 extend perpendicular to the page. FIGS. 31(a), 31(b), 31(d), and 31(e) show the apparatus 91000 in an example of an “open state,” and FIG. 31(c) shows the apparatus 91000 in an example of a “closed state.”

At an initial stage, as seen in FIG. 31(a), apparatus 91000 is off to one side (in a direction generally perpendicular to elongate members 92000) of elongate members 92000, with first and second chamber parts 9100, 9200 separated.

In FIG. 31(b), the elongate members 92000 and cleaning apparatus 91000 are moved relative to each other in a known manner so that elongate members 92000 are interposed between the still-separated first and second chamber parts 9100, 9200. In particular, each elongate member is substantially aligned with corresponding trenches 9104f and alignment grooves 9104g in first chamber part 9100 and slits 9202f and alignment grooves 9202g in second chamber part 9200.

In FIG. 31(c), actuator 9300 is driven to move first and second chamber parts 9100, 9200 toward each other. For example, pneumatic source 9302b is actuated to pull push-pull rod 9302 towards a closed position. Because a distal end of push-pull rod 9302 is engaged with first chamber part 9100, first chamber part 9100 is pulled towards second chamber part 9200. The force with which first and second chamber parts 9100, 9200 press against each other (under the influence of actuator 9300) is, in one working example, between 80-90 psi. After first and second chamber parts 9100, 9200 are engaged, cleaning fluid is introduced into the cleaning chambers defined therein and the ultrasonic transducers are activated for a required period of time. Because of the structure of apparatus 91000, the elongate members 92000 are cleaned using only the ultrasonically excited cleaning fluid, and no physical contact with another cleaning structure (e.g., wiping with a cloth) is needed to clean the elongate members 92000. Therefore, the elongate members 92000 are protected from scratching and the like.

In addition, it may be desirable to clean only an intermediate portion of the elongate members 92000, excluding the distal end portion. For example, it is possible that the distal ends of elongate members 92000 may be relatively more subject to damage than an intermediate portion of the elongate members. In the case of optical fibers, for example, an intermediate portion of the optical fibers is usually protected by a protective coating or sheath. Subsequently, cleaving is performed within the cleaned intermediate portion.

In an example of the present invention using 20 mm diameter transducers, cleaning chambers about 3.5 mm wide and about 16 mm long, and an oscillating frequency of about 103 kHz, it has been found that an elongate member such as a stripped optical fiber can be suitably cleaned in about 15 seconds or less, compared to about 30 seconds in a conventional ultrasonic cleaning tub. When this halving of cleaning time is multiplied over a total throughput, considerable time savings can be realized.

In FIG. 31(d), after a cleaning process is completed, the first and second chamber parts 9100, 9200 are separated by, for example, the action of actuator 9300. For example, pneumatic source 9302b may be operated to push push-pull rod 9302 outwardly, thereby forcing first chamber part 9100 away from second chamber part 9200. If desired, the pump 91002 and/or vacuum 91003 may be operated in a manner to evacuate some or all of the cleaning fluid in the cleaning chamber(s) before the first and second chamber parts are moved apart from each other, thereby further reducing spillage and the like.

In FIG. 31(e), cleaning apparatus 91000 is again withdrawn to one side relative to elongate members 92000 so that elongate members 92000 can be utilized or further processed as may be needed.

Where a contactless cleaning station 1201 is used, such as a shower-type cleaning station, the unit 1200 may include the pump coupled to the main body 1214. Alternatively, the pump may be physically separate and apart from the main body 1214. This may be advantageous where, e.g., the unit 1200 is mounted to a workbench and it is desirable to be able to easily access the pump (e.g., for changing the filter or repairing the pump) by installing the pump under the workbench or elsewhere.

Thus, various exemplary embodiments of an automatic fiber preparation unit have been described that address at least some of the problems with conventional optical fiber processing machines. The designs of some of the embodiments allow the parts of the unit to be disposed relatively close together, thus allowing the total volume of the unit to be compact. For instance, at least some of the disclosed embodiments are efficiently arranged, and include parts that move in a particularly efficient fashion, such that the unit could be made portable enough to be set on a workbench. Also, where multiple fibers share common stations, the unit may more easily be designed to be made compact, lightweight, simple, fast, and reliable. For example, as discussed previously, a single stripping station, cleaning station, and/or cleaving station may process two or more optical fibers simultaneously or substantially simultaneously. Such parallel processing can save time without impacting the quality of the prepared optical fibers.

While exemplary systems and methods embodying the present invention are shown by way of example, it will be understood that the invention is not limited to these embodiments. Modifications may be made by those skilled in the art, particularly in light of the foregoing teachings. For example, each of the elements of the aforementioned embodiments may be utilized alone or in combination with elements of the other embodiments.

Also, where the terms left, right, up, down, behind, in front, inward, above, and below, are used to describe the relative positions and directions of various elements of automatic fiber preparation units, the invention is not limited thereto and these elements may be located with respect to each other in many variations. For instance, the pivoting or rotation of carriages may be in directions other than in a downward direction, and the carriages may pivot to allow steps to be performed other than cleaning, such as stripping or cleaving. Also, the translation of any of the devices, systems, or other moving parts described herein may be linear or nonlinear as desired, and translation velocities and rotation speeds may be fixed or variable. Further, any of the X, Y, and Z axes used to help describe the exemplary embodiments may be interchanged and may be either orthogonal, substantially orthogonal, transverse, or non-orthogonal to each other. Also, various known cleaving devices, stripping devices, and cleaning devices may be modified to be incorporated into the optical fiber preparation units disclosed herein, and one of ordinary skill in the relevant art upon reading the present specification and drawings would understand how to do so with minimal experimentation. Also, all references herein to an optical fiber include any type of optical fiber of any thickness or configuration, including single-core or multiple-core optical fibers, as well as a ribbon-type optical fiber that include a plurality of optical fibers coupled together in a ribbon configuration.

What is claimed is:

1. An apparatus for automatically preparing at least one optical fiber, the apparatus comprising:
a stripping station at a first location, said stripping station configured to strip a first optical fiber;
a cleaning station at a second location, said cleaning station configured to clean the first optical fiber;
a cleaving station at a third location, said cleaving station configured to cleave the first optical fiber,
wherein the first optical fiber is stripped by the stripping station, cleaned by the cleaning station, and cleaved by the cleaving station while the first optical fiber remains in a fixed location.

2. The apparatus of claim 1, wherein the stripping station is configured to translate along a first direction.

3. The apparatus of claim 2, wherein the cleaning station is configured to translate along a second direction orthogonal to the first direction.

4. The apparatus of claim 3, wherein the cleaving station is configured to translate along a third direction orthogonal to both the first and second directions.

5. The apparatus of claim 2, further including a clamp configured to hold the first optical fiber in a fixed position during stripping, cleaning, and cleaving.

6. The apparatus of claim 1, further including a vacuum configured to collect a portion of the first optical fiber that is removed by cleaving.

7. The apparatus of claim 6, wherein the vacuum has a plenum and a hollow elongated member extending from the plenum toward the stripping station, the hollow elongated member applying vacuum to an area immediately adjacent to the stripping station.

8. The apparatus of claim 7, wherein the plenum has a length at least as long as the portion of the first optical fiber that is removed by cleaving.

9. The apparatus of claim 1, wherein the apparatus is further configured to prepare a second optical fiber physically separate and apart from the first optical fiber, at least one of the stripping, cleaning, and cleaving stations being configured to process the second optical fiber substantially simultaneously with the first optical fiber.

10. An apparatus for automatically preparing at least one optical fiber, the apparatus comprising:
a stripping station configured to translate along a longitudinal direction of the optical fiber in order to strip an optical fiber;
a cleaving station configured to translate in a second direction different than the first direction in order to cleave the optical fiber; and
a cleaning station configured to translate in a third direction different than both the first and second directions in order to clean the optical fiber.

11. The apparatus of claim 10, further including a first clamp configured to hold a first portion of the optical fiber in place during stripping, cleaning, and cleaving.

12. The apparatus of claim 10, further including a second clamp configured to hold a second portion the optical fiber during at least cleaving, the first and second portions of the optical fiber being disposed on opposite sides of a point where the optical fiber is cleaved.

13. The apparatus of claim 12, wherein the first and second clamps are configured to apply a longitudinal tension to the optical fiber of between 150 and 250 grams of force.

14. An apparatus for automatically preparing at least one optical fiber, the apparatus comprising:
a stripping station configured to strip a first optical fiber;
a cleaning station configured to clean the first optical fiber; and
a cleaving station configured to cleave the first optical fiber, the cleaving station including a disk for cleaving the first optical fiber, the disk comprising:
a circular central portion,
an outer portion disposed around a circumference of the central portion, the outer portion being edge-beveled, and
a diamond layer disposed on at least a portion of the outer portion.

15. The apparatus of claim 14, wherein the outer portion is an outer approximately 0.5 millimeter section of the disk, the outer portion being approximately 6 microns in thickness at a thickest location.

16. The apparatus of claim 14, wherein the apparatus is further configured to process a second optical fiber physically separate and apart from the first optical fiber, the outer portion of the disk physically contacting the first second optical fibers substantially simultaneously during cleaving.

17. The apparatus of claim 16, wherein the disk rotates about a rotation axis, an angle between the first and second optical fibers as measured from the rotation axis is at least 10 degrees during cleaving.

18. An apparatus for automatically preparing at least one optical fiber, the apparatus comprising:
a stripping station configured to strip an optical fiber;
a cleaning station configured to clean the optical fiber; and
a cleaving station configured to cleave the optical fiber, the cleaving station including:
a cleaving edge,
a first body,
a second body coupled to the cleaving edge and configured to translate in a linear direction relative to the first body in order to cleave the optical fiber, and
a cam rotatably coupled to the first body and configured to contact the second body when the second body reaches a first position relative to the first body, the cam configured to rotate while remaining in contact with the second body at least until the second body reaches a second position relative to the first body.

19. The apparatus of claim 18, wherein the cleaving edge comprises an edge of a disk, the apparatus further including a motor configured to spin the disk.

20. The apparatus of claim 19, wherein the motor is configured to spin the disk between 700 and 900 rotations per minute.

21. The apparatus of claim 19, wherein the motor is an electric motor.

22. An apparatus for automatically preparing at least one optical fiber, the apparatus comprising:
a stripping station configured to strip an optical fiber;
a cleaning station configured to clean the optical fiber; and
a cleaving station configured to cleave the optical fiber, the cleaving station including:
a disk,
a motor configured to spin the disk, and
a body coupled to the disk and configured to translate the disk toward the optical fiber at a first speed until the disk reaches a certain distance from the optical fiber, at which point the body translates the disk toward the optical fiber at a second speed slower than the first speed.

23. The apparatus of claim 22, wherein the second speed is between 0.01 and 0.1 millimeters per second.

24. The apparatus of claim 23, wherein the certain distance is between 0.01 and 2 millimeters of translation prior to an edge of the disk touching the optical fiber.

25. The apparatus of claim 22, wherein the motor is an electric motor.

26. An apparatus for automatically preparing at least one optical fiber for splicing, the apparatus comprising:
a stripping station configured to strip a first optical fiber;
a contactless cleaning station configured to clean the first optical fiber; and
a cleaving station configured to cleave the first optical fiber.

27. The apparatus of claim 26, further including a pump coupled to the contactless cleaning station and configured to deliver fluid to the contactless cleaning station.

28. The apparatus of claim 27, wherein the pump is coupled to a common body, the common body also being coupled to at least one of the stripping station, the contactless cleaning station, and the cleaving station.

29. The apparatus of claim 26, wherein the apparatus is further configured to process a second optical fiber physically separate and apart from the first optical fiber, the contactless cleaning station being configured to clean the first and second optical fibers substantially simultaneously.

30. The apparatus of claim 29, wherein the cleaving station is configured to cleave the first and second optical fibers substantially simultaneously.

31. The apparatus of claim 26, wherein the apparatus is further configured to process a second optical fiber physically separate and apart from the first optical fiber, the stripping station having at least two physically separate and apart blades each configured to strip a different one of the first and second optical fibers.

32. The apparatus of claim 26, wherein the contactless cleaning station is configured to translate toward the first optical fiber in a first direction.

33. The apparatus of claim 32, wherein the cleaving station is configured to translate toward the first optical fiber in a second direction.

34. The apparatus of claim 32, wherein the stripping station is configured to translate toward the first optical fiber in a third direction, the third direction being transverse to the first direction.

35. The apparatus of claim 26, wherein the contactless cleaning station is configured to translate toward the first optical fiber in a first direction, the cleaving station is configured to translate toward the first optical fiber in a second direction, and the stripping station is configured to translate toward the first optical fiber in a third direction, the first, second, and third directions all being transverse to one another.

36. The apparatus of claim 26, wherein the contactless cleaning station is configured to translate toward the first optical fiber in a first direction, the cleaving station is configured to translate toward the first optical fiber in a second direction, and the stripping station is configured to translate toward the first optical fiber in a third direction, the first, second, and third directions all being substantially perpendicular to one another.

37. The apparatus of claim 26, further including:
a clamp configured to clamp the first optical fiber; and
a carriage coupled to the stripping station and to the clamp and configured to translate both the stripping station and the clamp together.

38. The apparatus of claim 37, wherein carriage is configured to translate the stripping station and the clamp along a longitudinal axis of the first optical fiber.

39. The apparatus of claim 26, further including a vacuum configured to collect a portion of the first optical fiber that is removed by cleaving.

40. The apparatus of claim 26, wherein the apparatus has a footprint of less than or equal to 576 square inches

41. An apparatus for automatically preparing at least one optical fiber, the apparatus comprising:
a stripping station configured to strip a first optical fiber;
a cleaning station configured to clean the first optical fiber;
a cleaving station configured to cleave the first optical fiber; and
a vacuum configured to collect a scrap portion of the first optical fiber removed by cleaving, the vacuum including:
a first plenum configured to receive the scrap portion,
a second plenum coupled to the first plenum via a first air-transmitting portion that allows the passage of air but does not allow the scrap portion to pass through, and
a vacuum source coupled to the second plenum and providing a vacuum to the second plenum.

42. The apparatus of claim 41, wherein the first air-transmitting portion comprises at least one of a screen and a mesh.

43. The apparatus of claim 41, wherein the apparatus is configured to process a second optical fiber physically separate and apart from the first optical fiber, the vacuum further including a third plenum coupled to at least one of the first plenum and the second plenum via a second air-transmitting portion that allows the passage of air but does not allow the scrap portion to pass through, the third plenum configured to receive a scrap portion of the second optical fiber removed by cleaving.

44. The apparatus of claim 41, further including a hollow elongated plenum member coupled to the first plenum and configured to receive the first optical fiber through the elongated plenum member.
